(19) United States
(12) Patent Application Publication
(10) Pub. No.: US 2024/0155583 A1
(43) Pub. Date: May 9, 2024

(54) SUBBAND CONFIGURATION IN FULL-DUPLEX SYSTEMS

(71) Applicant: Samsung Electronics Co., Ltd., Suwon-si (KR)

(72) Inventors: Marian Rudolf, Longueuil (CA); Aristides Papasakellariou, Houston, TX (US)

(21) Appl. No.: 18/492,601

(22) Filed: Oct. 23, 2023

Related U.S. Application Data
(60) Provisional application No. 63/422,207, filed on Nov. 3, 2022.
(60) Provisional application No. 63/457,623, filed on Apr. 6, 2023.

(51) Int. Cl. H04W 72/0453; H04L 5/14

(52) U.S. Cl. CPC H04W 72/0453; H04L 5/14

(57) ABSTRACT

Apparatuses and methods for utilizing a subband configuration in full-duplex systems. A method of operating a user equipment (UE) includes receiving first information for a first set of parameters for a first frequency-domain subband associated with an uplink (UL) bandwidth for transmissions on a cell; receiving second information for a second set of parameters for a second frequency-domain subband associated with a downlink (DL) bandwidth for receptions on the cell; and determining a third frequency-domain subband on a symbol based on the first frequency-domain subband, the second frequency-domain subband, and a reference bandwidth. The method further includes receiving or transmitting on the symbol. A frequency-domain resource of the third frequency-domain subband is not available for receptions or transmissions on the symbol on the cell.

### CROSS-REFERENCE TO RELATED APPLICATION AND CLAIM OF PRIORITY

This application claims priority under 35 U.S.C. § 119(e) to U.S. Provisional Patent Application No. 63/422,207 filed on Nov. 3, 2022 and U.S. Provisional Patent Application No. 63/457,623 filed on Apr. 6, 2023. The above-identified provisional patent applications are hereby incorporated by reference in their entirety.

### TECHNICAL FIELD

The present disclosure relates generally to wireless communication systems and, more specifically, relates to subband configuration in full-duplex systems.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure relates to subband configuration in full-duplex systems.

In an embodiment, a method of operating a user equipment (UE) is provided. The method includes receiving first information for a first set of parameters for a first frequency-domain subband associated with an uplink (UL) bandwidth for transmissions on a cell; receiving second information for a second set of parameters for a second frequency-domain subband associated with a downlink (DL) bandwidth for receptions on the cell; and determining a third frequency-domain subband on a symbol based on the first frequency-domain subband, the second frequency-domain subband, and a reference bandwidth. At least one of the first frequency-domain subband and the second frequency-domain subband is one of a subband full-duplex (SBFD) DL subband, an SBFD flexible subband, or an SBFD UL subband. The reference bandwidth is one of a carrier bandwidth, a bandwidth part (BWP), or a frequency-domain allocation with upper and lower limits. The method further includes receiving or transmitting on the symbol. A frequency-domain resource of the third frequency-domain subband is not available for receptions or transmissions on the symbol on the cell.

In another embodiment, a UE is provided. The UE includes a transceiver configured to receive first information for a first set of parameters for a first frequency-domain subband associated with an UL bandwidth for transmissions on a cell and receive second information for a second set of parameters for a second frequency-domain subband associated with a DL bandwidth for receptions on the cell. The UE further includes a processor configured to determine a third frequency-domain subband on a symbol based on the first frequency-domain subband, the second frequency-domain subband, and a reference bandwidth. At least one of the first frequency-domain subband and the second frequency-domain subband is one of a SBFD DL subband, an SBFD Flexible subband, or an SBFD UL subband. The reference bandwidth is one of a carrier bandwidth, a BWP, or a frequency-domain allocation with upper and lower limits. The transceiver is further configured to receive or transmit on the symbol. A frequency-domain resource of the third frequency-domain subband is not available for receptions or transmissions on the symbol on the cell.

In yet another embodiment, a base station (BS) is provided. The BS includes a transceiver configured to transmit first information for a first set of parameters for a first frequency-domain subband associated with an UL bandwidth for receptions on a cell; and transmit second information for a second set of parameters for a second frequency-domain subband associated with a DL bandwidth for transmissions on the cell. The BS further includes a processor configured to determine a third frequency-domain subband on a symbol based on the first frequency-domain subband, the second frequency-domain subband, and a reference bandwidth. At least one of the first frequency-domain subband and the second frequency-domain subband is one of a SBFD DL subband, an SBFD flexible subband, or an SBFD UL subband. The reference bandwidth is one of a carrier bandwidth, a BWP, or a frequency-domain allocation with upper and lower limits. The transceiver is further configured to receive or transmit on the symbol. A frequency-domain resource of the third frequency-domain subband is not available for receptions or transmissions on the symbol on the cell.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example base station according to embodiments of the present disclosure;

FIG. 3 illustrates an example user equipment (UE) according to embodiments of the present disclosure;

FIGS. 4A-B illustrate example wireless transmit and receive paths according to embodiments of the present disclosure;

FIG. 5 illustrates a transmitter block diagram for a physical downlink shared channel (PDSCH) in a slot according to embodiments of the present disclosure;

FIG. 6 illustrates a receiver block diagram for a PDSCH in a slot according to embodiments of the present disclosure;

FIG. 7 illustrates a transmitter block diagram for a physical uplink shared channel (PUSCH) in a slot according to embodiments of the present disclosure;

FIG. 8 illustrates a receiver block diagram for a PUSCH in a slot according to embodiments of the present disclosure;

FIG. 9 illustrates an example antenna blocks or arrays forming beams according to embodiments of the present disclosure;

FIG. 10 illustrates an example uplink/downlink (UL-DL) frame configuration in a time-division duplex (TDD) communication system configuration in accordance with various embodiments of this disclosure;

FIG. 11 illustrates an example UL-DL frame configurations in a full-duplex (FD) communication system, in accordance with various embodiments of this disclosure;

FIG. 12 illustrates an example for guard band determination based on Subband-Full-Duplex (SBFD) UL and DL subbands, in accordance with various embodiments of this disclosure;

FIG. 13 illustrates an example user equipment (UE) processing flowchart for guard band determination, in accordance with various embodiments of this disclosure;

FIG. 14 illustrates a diagram for SBFD DL subband determination base don SBFD UL subband and SBFD guard band, in accordance with various embodiments of this disclosure;

FIG. 15 illustrates a flow chart of a UE process for SBFD DL subband determination, in accordance with various embodiments of this disclosure;

FIG. 16 illustrates a flow chart for determination of an SBFD subband configuration based on a reference bandwidth part (BWP), in accordance with various embodiments of this disclosure;

FIG. 17 illustrates a diagram for indication of DL schedulable symbols/slots of RRC associated with an UL subband configuration, in accordance with embodiments of this disclosure;

FIG. 18 illustrates a UE processing flowchart to determine DL schedulable symbols/slots associated with an UL subband configuration, in accordance with embodiments of this disclosure;

FIG. 19 illustrates a diagram of separate RRC provided SBFD subband configurations for RRC_IDLE and RRC_CONNECTED, in accordance with embodiments of this disclosure;

FIG. 20 illustrates a UE processing flowchart to determine applicable SBFD subband configurations associated with RRC state(s), in accordance with more embodiments of this disclosure.

### DETAILED DESCRIPTION

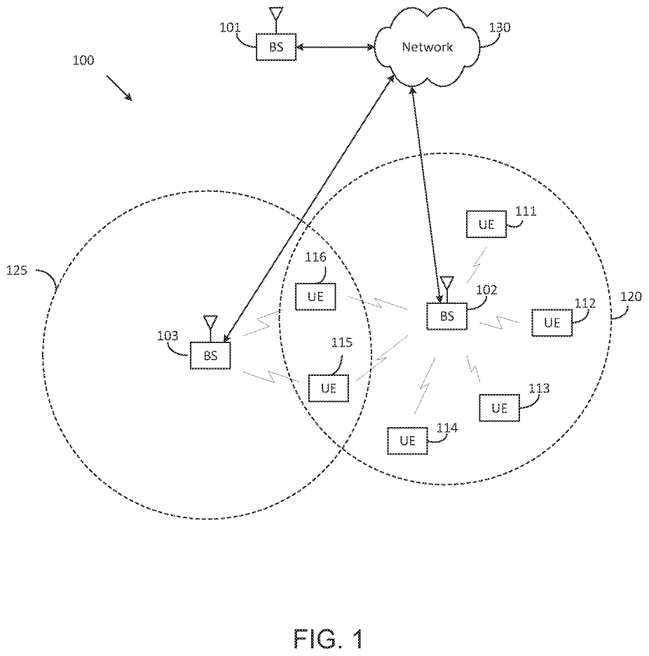

FIGS. 1 through 20, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

The following documents and standards descriptions are hereby incorporated by reference into the present disclosure as if fully set forth herein: 3GPP NR specifications, 3GPP TS 38.211 v 17.2.0, “NR; Physical channels and modulation” (REF1); 3GPP TS 38.212 v 17.2.0, “NR; Multiplexing and Channel coding” (REF2); 3GPP TS 38.213 v 17.2.0, “NR; Physical Layer Procedures for Control” (REF3); 3GPP TS 38.214 v 17.2.0, “NR; Physical Layer Procedures for Data” (REF4); 3GPP TS 38.321 v 17.1.0, “NR; Medium Access Control (MAC) protocol specification” (REF5); 3GPP TS 38.331 v 17.1.0, “NR; Radio Resource Control (RRC) Protocol Specification” (REF6); and 3GPP TS 38.306 v 17.1.0, “NR; User Equipment (UE) radio access capabilities” (REF7); 3GPP TS 38.101-1 v. 16.6.0, “NR; UE radio transmission and reception; Part 1: Range 1 Standalone” (REF8); 3GPP TS 38.101-2 v. 16.9.0, “NR; UE radio transmission and reception; Part 2: Range 2 Standalone” (REF9); 3GPP TS 38.101-3 v. 16.9.0, “NR; UE radio transmission and reception; Part 3: Range 1 and Range 2 Interworking operation with other radios” (REF10); and 3GPP TS 38.133 v 16.8.0, “NR; Requirements for support of radio resource management” (REF11).

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for identifying and/or utilizing a subband configuration in full-duplex systems. In certain embodiments, one or more of the BSs 101-103 include circuitry, programing, or a combination thereof for identifying and/or utilizing a subband configuration in full-duplex systems.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

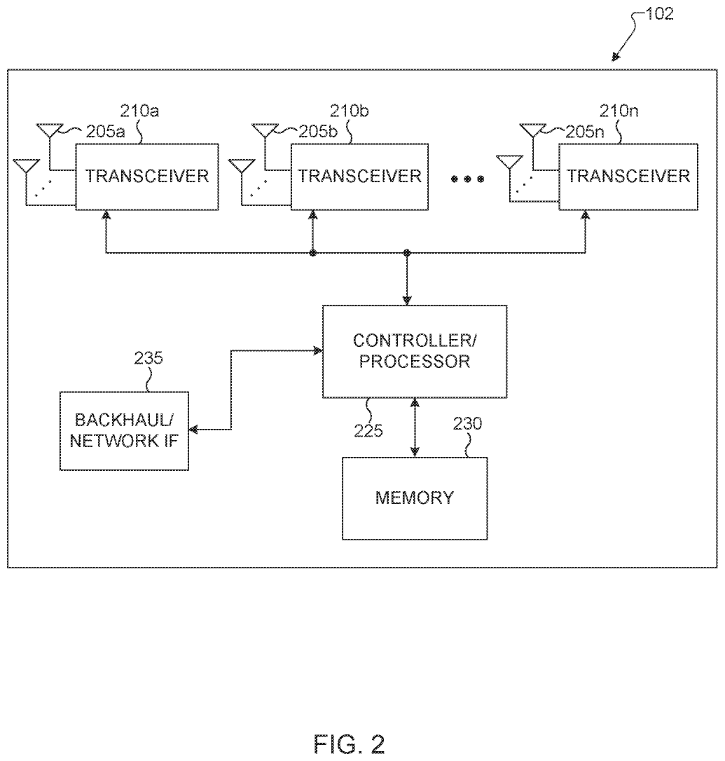

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for identifying and/or utilizing a subband configuration in full-duplex systems as described in greater detail below. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

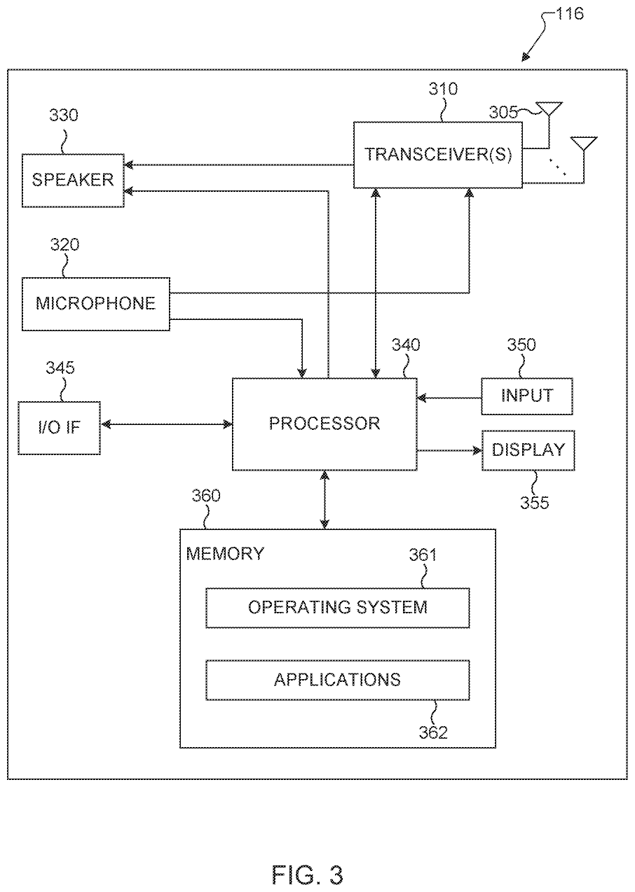

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for identifying and/or utilizing a subband configuration in full-duplex systems as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

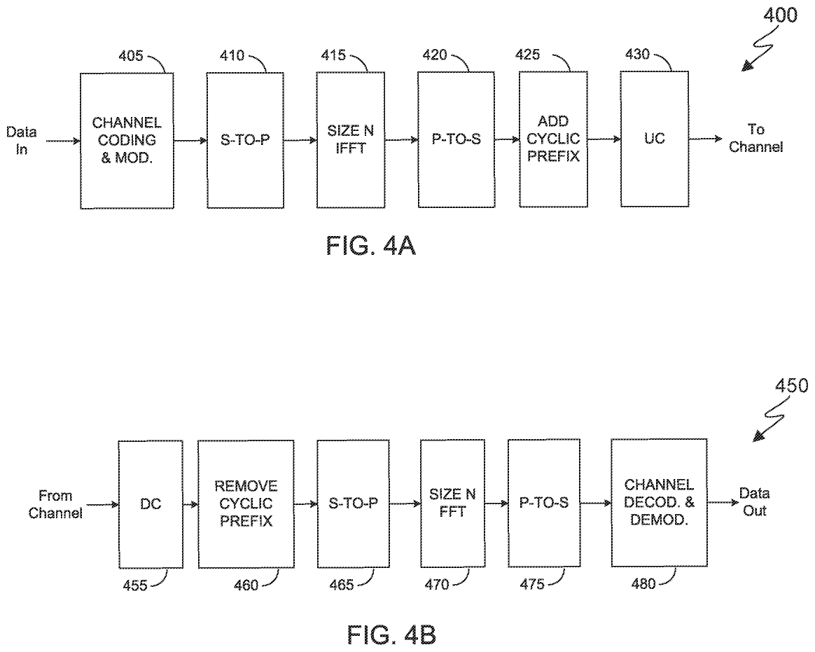

FIGS. 4A-B illustrate example wireless transmit and receive paths according to this disclosure. In the following description, a transmit path 400 of FIG. 4A, may be described as being implemented in an gNB (such as the gNB 102), while a receive path 450 of FIG. 4B, may be described as being implemented in a UE (such as a UE 116). However, it may be understood that the receive path 450 can be implemented in a BS and that the transmit path 400 can be implemented in a UE. In some embodiments, the receive path 450 is configured to identify and/or utilize a subband configuration in full-duplex systems as described in embodiments of the present disclosure.

The transmit path 400 as illustrated in FIG. 4A includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 450 as illustrated in FIG. 4B includes a down-converter (DC) 455, a remove cyclic prefix block 460, a serial-to-parallel (S-to-P) block 465, a size N fast Fourier transform (FFT) block 470, a parallel-to-serial (P-to-S) block 475, and a channel decoding and demodulation block 480.

As illustrated in FIG. 4A, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at a UE (e.g., 116) after passing through the wireless channel, and reverse operations to those at the gNB 102 are performed at the UE (e.g., 116).

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time domain signals. The size N FFT block 470 performs an FFT algorithm to generate N parallel frequency-domain signals. The parallel-to-serial block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 as illustrated in FIG. 4A that is analogous to transmitting in the downlink to UEs 111-116 and may implement a receive path 500 as illustrated in FIG. 4B that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4A and FIG. 4B can be implemented using hardware or using a combination of hardware and software/firmware. As a particular example, at least some of the components in FIG. 4 and FIG. 4B may be implemented in software, while other components may be implemented by configurable hardware or a mixture of software and configurable hardware. For instance, the FFT block 470 and the IFFT block 515 may be implemented as configurable software algorithms, where the value of size N may be modified according to the implementation.

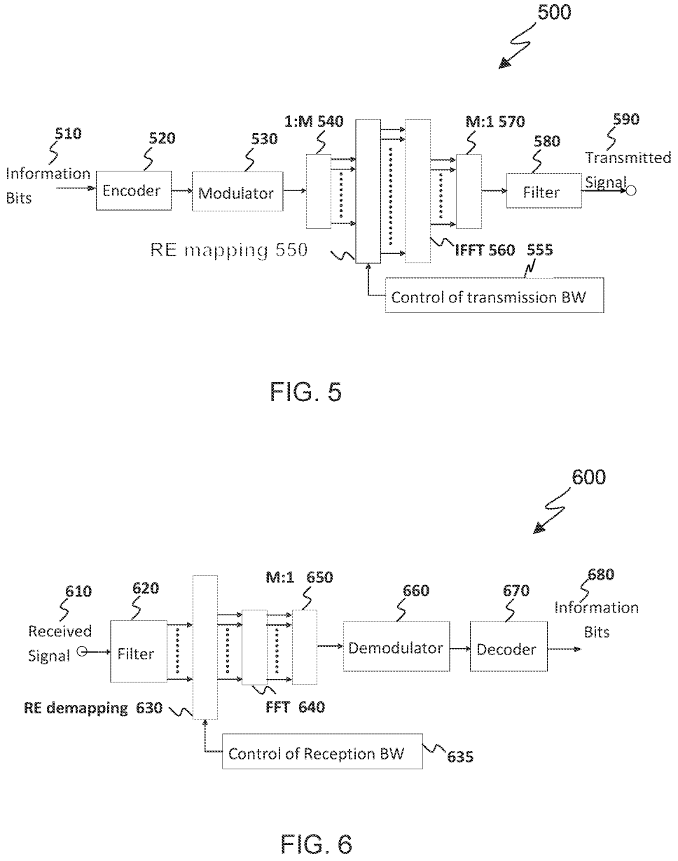

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions. FIGS. 4 and 5 may also be generally implemented using TDD UL-DL operations.

Although FIGS. 4A-B illustrate examples of wireless transmit and receive paths, various changes may be made to FIGS. 4A-B. For example, various components in FIGS. 4A-B can be combined, further subdivided, or omitted and additional components can be added according to particular needs. Also, FIGS. 4A-B are meant to illustrate examples of the types of transmit and receive paths that can be used in a wireless network. Any other suitable architectures can be used to support wireless communications in a wireless network.

A communication system can include a downlink (DL) that refers to transmissions from a base station (such as the BS 102) or one or more transmission points to UEs (such as the UE 116) and an uplink (UL) that refers to transmissions from UEs (such as the UE 116) to a base station (such as the BS 102) or to one or more reception points.

A time unit for DL signaling or for UL signaling on a cell is referred to as a slot and can include one or more symbols. A symbol can also serve as an additional time unit. A frequency (or bandwidth (BW)) unit is referred to as a resource block (RB). One RB includes a number of sub-carriers (SCs). For example, a slot can have duration of 1 millisecond or 0.5 millisecond, include 14 symbols and an RB can include 12 SCs with inter-SC spacing of 15 kHz or 30 kHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format.

A gNB (such as the BS 102) transmits one or more of multiple types of RS including channel state information RS (CSI-RS) and demodulation RS (DM-RS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process consists of NZP CSI-RS and CSI-IM resources.

A UE (such as the UE 116) can determine CSI-RS transmission parameters through DL control signaling or higher layer signaling, such as radio resource control (RRC) signaling, from a gNB (such as the BS 102). Transmission instances of a CSI-RS can be indicated by DL control signaling or be configured by higher layer signaling. A DM-RS is transmitted only in the BW of a respective PDCCH or PDSCH and a UE can use the DM-RS to demodulate data or control information.

In certain embodiments, UL signals also include data signals conveying information content, control signals conveying UL control information (UCI), DM-RS associated with data or UCI demodulation, sounding RS (SRS) enabling a gNB to perform UL channel measurement, and a RA preamble enabling a UE to perform RA (see also NR specification). A UE transmits data information or UCI through a respective PUSCH or a physical UL control channel (PUCCH). A PUSCH or a PUCCH can be transmitted over a variable number of slot symbols including one slot symbol. The gNB can configure the UE to transmit signals on a cell within an active UL bandwidth part (BWP) of the cell UL BW.

UCI includes HARQ acknowledgement (ACK) information, indicating correct or incorrect detection of data transport blocks (TBs) in a PDSCH, scheduling request (SR) indicating whether a UE has data in a buffer, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER (see NR specification), of a precoding matrix indicator (PMI) informing a gNB how to combine signals from multiple transmitter antennas in accordance with a MIMO transmission principle, and of a rank indicator (RI) indicating a transmission rank for a PDSCH.

UL RS includes DM-RS and SRS. DM-RS is transmitted only in a BW of a respective PUSCH or PUCCH transmission. A gNB can use a DM-RS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel (PRACH as shown in NR specifications).

An antenna port is defined such that the channel over which a symbol on the antenna port is conveyed can be inferred from the channel over which another symbol on the same antenna port is conveyed.

For DM-RS associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same precoding resource block group (PRG).

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE may assume the same precoding being used.

For DM-RS associated with a physical broadcast channel (PBCH), the channel over which a PBCH symbol on one antenna port is conveyed can be inferred from the channel over which a DM-RS symbol on the same antenna port is conveyed only if the two symbols are within a SS/PBCH block transmitted within the same slot, and with the same block index.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE (such as the UE 116) may assume that synchronization signal (SS)/PBCH block (also denoted as SSBs) transmitted with the same block index on the same center frequency location are quasi co-located with respect to Doppler spread, Doppler shift, average gain, average delay, delay spread, and, when applicable, spatial Rx parameters. The UE may not assume quasi co-location for any other synchronization signal SS/PBCH block transmissions.

In absence of CSI-RS configuration, and unless otherwise configured, the UE may assume PDSCH DM-RS and SSB to be quasi co-located with respect to Doppler shift, Doppler spread, average delay, delay spread, and, when applicable, spatial Rx parameters. The UE may assume that the PDSCH DM-RS within the same code division multiplexing (CDM) group is quasi co-located with respect to Doppler shift, Doppler spread, average delay, delay spread, and spatial Rx. The UE may also assume that DM-RS ports associated with a PDSCH are QCL with QCL type A, type D (when applicable) and average gain. The UE may further assume that no DM-RS collides with the SS/PBCH block.

The UE can be configured with a list of up to M transmission configuration indication (TCI) State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi-colocation (QCL) relationship between one or two downlink reference signals and the DM-RS ports of the PDSCH, the DM-RS port of PDCCH or the CSI-RS port(s) of a CSI-RS resource.

The quasi co-location relationship is configured by the higher layer parameter qcl-Type1 for the first DL RS, and qcl-Type2 for the second DL RS (if configured). For the case of two DL RSs, the QCL types may not be the same, regardless of whether the references are to the same DL RS or different DL RSs. The quasi co-location types corresponding to each DL RS are given by the higher layer parameter qcl-Type in QCL-Info and may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

The UE receives a MAC-CE activation command to map up to [N] (e.g., N=8) TCI states to the codepoints of the DCI field “Transmission Configuration Indication.” When the HARQ-ACK corresponding to the PDSCH carrying the activation command is transmitted in slot n, the indicated mapping between TCI states and codepoints of the DCI field “Transmission Configuration Indication” may be applied after a MAC-CE application time, e.g., starting from the first slot that is after slot (n+3Nₛₗₒₜ^{subframe,μ}) where Nₛₗₒₜ^{subframe,μ} is a number of slot per subframe for subcarrier spacing (SCS) configuration μ.

FIG. 5 illustrates a transmitter block diagram 500 for a PDSCH in a slot according to embodiments of the present disclosure. The embodiment of the transmitter block diagram 500 illustrated in FIG. 5 is for illustration only. One or more of the components illustrated in FIG. 5 can be implemented in specialized circuitry configured to perform the noted functions or one or more of the components can be implemented by one or more processors executing instructions to perform the noted functions. FIG. 5 does not limit the scope of this disclosure to any particular implementation of the transmitter block diagram 500.

As shown in FIG. 5, information bits 510 are encoded by encoder 520, such as a turbo encoder, and modulated by modulator 530, for example using quadrature phase shift keying (QPSK) modulation. A serial to parallel (S/P) converter 540 generates M modulation symbols that are subsequently provided to a mapper 550 to be mapped to REs selected by a transmission BW selection unit 555 for an assigned PDSCH transmission BW, unit 560 applies an Inverse fast Fourier transform (IFFT), the output is then serialized by a parallel to serial (P/S) converter 570 to create a time domain signal, filtering is applied by filter 580, and a signal transmitted 590. Additional functionalities, such as data scrambling, cyclic prefix insertion, time windowing, interleaving, and others are well known in the art and are not shown for brevity.

FIG. 6 illustrates a receiver block diagram 600 for a PDSCH in a slot according to embodiments of the present disclosure. The embodiment of the diagram 600 illustrated in FIG. 6 is for illustration only. One or more of the components illustrated in FIG. 6 can be implemented in specialized circuitry configured to perform the noted functions or one or more of the components can be implemented by one or more processors executing instructions to perform the noted functions. FIG. 6 does not limit the scope of this disclosure to any particular implementation of the diagram 600.

As shown in FIG. 6, a received signal 610 is filtered by filter 620, REs 630 for an assigned reception BW are selected by BW selector 635, unit 640 applies a fast Fourier transform (FFT), and an output is serialized by a parallel-to-serial converter 650. Subsequently, a demodulator 660 coherently demodulates data symbols by applying a channel estimate obtained from a DMRS or a CRS (not shown), and a decoder 670, such as a turbo decoder, decodes the demodulated data to provide an estimate of the information data bits 680. Additional functionalities such as time-windowing, cyclic prefix removal, de-scrambling, channel estimation, and de-interleaving are not shown for brevity.

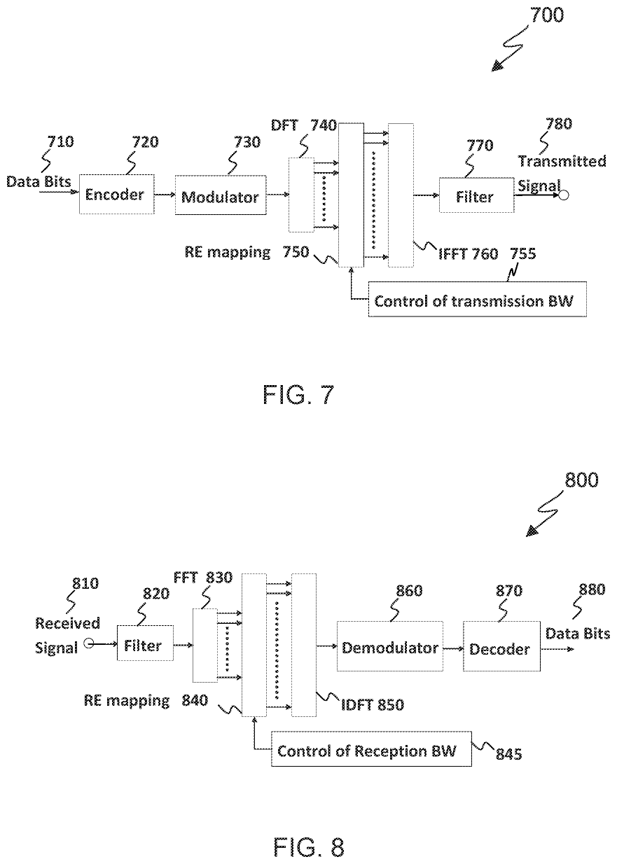

FIG. 7 illustrates a transmitter block diagram 700 for a PUSCH in a slot according to embodiments of the present disclosure. The embodiment of the block diagram 700 illustrated in FIG. 7 is for illustration only. One or more of the components illustrated in FIG. 5 can be implemented in specialized circuitry configured to perform the noted functions or one or more of the components can be implemented by one or more processors executing instructions to perform the noted functions. FIG. 7 does not limit the scope of this disclosure to any particular implementation of the block diagram 700.

As shown in FIG. 7, information data bits 710 are encoded by encoder 720, such as a turbo encoder, and modulated by modulator 730. A discrete Fourier transform (DFT) unit 740 applies a DFT on the modulated data bits, REs 750 corresponding to an assigned PUSCH transmission BW are selected by transmission BW selection unit 855, unit 760 applies an IFFT and, after a cyclic prefix insertion (not shown), filtering is applied by filter 770 and a signal transmitted 780.

FIG. 8 illustrates a receiver block diagram 800 for a PUSCH in a subframe according to embodiments of the present disclosure. The embodiment of the block diagram 800 illustrated in FIG. 8 is for illustration only. One or more of the components illustrated in FIG. 8 can be implemented in specialized circuitry configured to perform the noted functions or one or more of the components can be implemented by one or more processors executing instructions to perform the noted functions. FIG. 8 does not limit the scope of this disclosure to any particular implementation of the block diagram 800.

As shown in FIG. 8, a received signal 810 is filtered by filter 820. Subsequently, after a cyclic prefix is removed (not shown), unit 830 applies an FFT, REs 840 corresponding to an assigned PUSCH reception BW are selected by a reception BW selector 845, unit 850 applies an inverse DFT (IDFT), a demodulator 860 coherently demodulates data symbols by applying a channel estimate obtained from a DMRS (not shown), a decoder 870, such as a turbo decoder, decodes the demodulated data to provide an estimate of the information data bits 880.

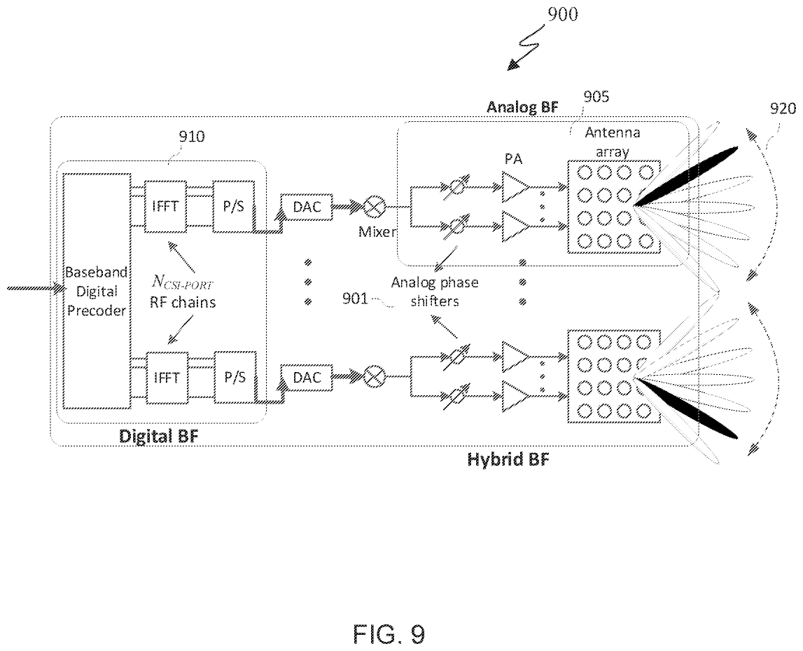

FIG. 9 illustrates an example antenna blocks or arrays 900 according to embodiments of the present disclosure. The embodiment of the antenna blocks or arrays 900 illustrated in FIG. 9 is for illustration only. FIG. 9 does not limit the scope of this disclosure to any particular implementation of the antenna blocks or arrays 900.

Rel-15 NR specifications support up to 32 CSI-RS antenna ports which enable a gNB to be equipped with a large number of antenna elements (such as 64 or 128). In this case, a plurality of antenna elements is mapped onto one CSI-RS port. For FR2, e.g., mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 9. In this case, one CSI-RS port is mapped onto a large number of antenna elements which can be controlled by a bank of analog phase shifters 901. One CSI-RS port can then correspond to one sub-array which produces a narrow analog beam through analog beamforming 905. This analog beam can be configured to sweep across a wider range of angles (920) by varying the phase shifter bank across symbols or subframes. The number of sub-arrays (equal to the number of RF chains) is the same as the number of CSI-RS ports N_{CSI-PORT}. A digital beamforming unit 910 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the above system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL transmit (TX) beam (also termed “beam indication”), measuring at least one reference signal for calculating and performing beam reporting (also termed “beam measurement” and “beam reporting”, respectively), and receiving a DL or UL transmission via a selection of a corresponding receive (RX) beam.

The above system is also applicable to higher frequency bands such as FR2-2, e.g., >52.6 GHz. In this case, the system can employ only analog beams. Due to the O2 absorption loss around 60 GHz frequency (˜10 dB additional loss @ 100 m distance), larger number of and sharper analog beams (hence larger number of radiators in the array) will be needed to compensate for the additional path loss.

In the present disclosure, the frequency resolution (reporting granularity) and span (reporting bandwidth) of CSI or calibration coefficient reporting can be defined in terms of frequency “subbands” and “CSI reporting band” (CRB), respectively.

A subband for CSI or calibration coefficient reporting is defined as a set of contiguous PRBs which represents the smallest frequency unit for CSI or calibration coefficient reporting. The number of PRBs in a subband can be fixed for a given value of DL system bandwidth, configured either semi-statically via higher layer/RRC signaling, or dynamically via L1 DL control signaling or MAC control element (MAC CE). The number of PRBs in a subband can be included in CSI or calibration coefficient reporting setting. The term “CSI reporting band” is defined as a set/collection of subbands, either contiguous or non-contiguous, wherein CSI or calibration coefficient reporting is performed. For example, CSI or calibration coefficient reporting band can include all the subbands within the DL system bandwidth. This can also be termed “fullband”. Alternatively, CSI or calibration coefficient reporting band can include only a collection of subbands within the DL system bandwidth. This can also be termed “partial band”. The term “CSI reporting band” is used only as an example for representing a function. Other terms such as “CSI reporting subband set” or “CSI or calibration coefficient reporting bandwidth” can also be used.

In terms of UE configuration, a UE can be configured with at least one CSI or calibration coefficient reporting band. This configuration can be semi-static (via higher layer signaling or RRC) or dynamic (via MAC CE or L1 DL control signaling). When configured with multiple (N) CSI or calibration coefficient reporting bands (e.g., via RRC signaling), a UE can report CSI associated with n≤N CSI reporting bands. For instance, >6 GHz, large system bandwidth may require multiple CSI or calibration coefficient reporting bands. The value of n can either be configured semi-statically (via higher layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mn subbands when one CSI parameter for all the Mn subbands within the CSI reporting band. A CSI parameter is configured with “subband” for the CSI reporting band with Mn subbands when one CSI parameter is reported for each of the Mn subbands within the CSI reporting band.

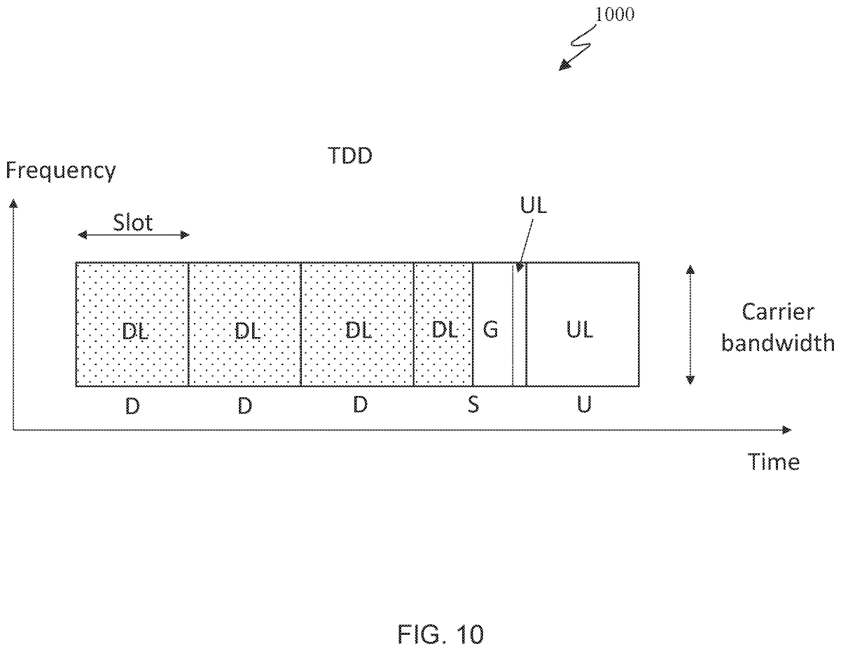

FIG. 10 illustrates an example Uplink Downlink (UL-DL) configuration of a frame comprising of slots in a time-division duplex (TDD) communications system 1000 according to the embodiments of this disclosure. The embodiment of the UL-DL configuration of a frame in a TDD communication system 1000 illustrated in FIG. 10 is for illustration only. FIG. 10 does not limit the scope of this disclosure to any particular implementation of the UL-DL frame configuration in a TDD communications system 1000. As will be described in further detail below, the UL-DL configuration exemplified in FIG. 10 may be used to facilitate communication between any of the gNBS (e.g., 101, 102, 103, etc.) with a UE (e.g., 111, 112, 113, etc.).

5G NR radio supports time-division duplex (TDD) operation and frequency division duplex (FDD) operation. Use of FDD or TDD depends on the NR frequency band and per-country allocations. TDD is required in most bands above 2.5 GHz. FIG. 10 illustrates an example structure of slots or single-carrier TDD UL-DL frame configuration for a TDD communications system according to the embodiments of the present disclosure.

In FIG. 10, D denotes a DL slot, U denotes an UL slot, and S denotes a special or switching slot with a DL part, a flexible part that can also be used as guard period G for DL-to-UL switching, and optionally an UL part.

TDD has several advantages over FDD. For example, use of the same band for DL and UL transmissions leads to simpler UE implementation with TDD because a duplexer is not required. Another advantage is that time resources can be flexibly assigned to UL and DL considering an asymmetric ratio of traffic in both directions. DL is typically assigned most time resources in TDD to handle DL-heavy mobile traffic. Another advantage is that CSI can be more easily acquired via channel reciprocity. This reduces an overhead associated with CSI reports especially when there is a large number of antennas.

Although there are advantages of TDD over FDD, there are also disadvantages. This disclosure recognizes that there is smaller coverage of TDD due to the smaller portion of time resources available for transmissions from a UE, while with FDD all time resources can be used. This disclosure also recognizes that TTD may be subject to latency. In TDD, a timing gap between reception by a UE and transmission from a UE containing the hybrid automatic repeat request acknowledgement (HARQ-ACK) information associated with receptions by the UE is typically larger than that in FDD, for example by several milliseconds. Therefore, the HARQ round trip time in TDD is typically longer than that with FDD, especially when the DL traffic load is high. This causes increased UL user plane latency in TDD and can cause data throughput loss or even HARQ stalling when a physical uplink control channel (PUCCH) providing HARQ-ACK information needs to be transmitted with repetitions in order to improve coverage (an alternative in such case is for a network to forgo HARQ-ACK information at least for some transport blocks in the DL).

To address some of the disadvantages for TDD operation, a dynamic adaptation of link direction may be utilized where, except for some symbols in some slots supporting predetermined transmissions such as for SSBs, symbols of a slot can have a flexible direction, e.g., DL or UL, which a UE can determine according to scheduling information for transmissions or receptions. A physical downlink control channel (PDCCH) can also be used to provide a DCI format, such as a DCI format 2.0 as described in REF3, that can indicate a link direction of some flexible symbols in one or more slots. Nevertheless, in actual deployments, it is difficult for a gNB scheduler to adapt a transmission direction of symbols without coordination with other gNB schedulers in the network. This is because of cross-link-interference (CLI) where, for example, DL receptions in a cell by a UE can experience large interference from UL transmissions in the same or neighboring cells from other UEs.

Full-duplex (FD) communications offer a potential for increased spectral efficiency, improved capacity, and reduced latency in wireless networks. When using FD communications, a gNB (e.g., 102, 103, etc.) or a UE (e.g., 111, 1112, 113, etc.) simultaneously receives and transmits on fully or partially overlapping, or adjacent, frequency resources, thereby improving spectral efficiency and reducing latency in user and/or control planes.

There are several options for operating a FD wireless communication system. For example, a single carrier may be used such that transmissions and receptions are scheduled on same time-domain resources, such as symbols or slots. Transmissions and receptions on same symbols or slots may be separated in frequency, for example by being placed in non-overlapping subbands. An UL frequency subband, in time-domain resources that also include DL frequency subbands, may be located in the center of a carrier, or at the edge of the carrier, or at a selected frequency-domain position of the carrier. The allocations of DL subbands and UL subbands may also partially or even fully overlap. A gNB may simultaneously transmit and receive in time-domain resources using same physical antennas, antenna ports, antenna panels and transmitter-receiver units (TRX). Transmission and reception in FD may also occur using separate physical antennas, ports, panels, or TRXs. Antennas, ports, panels, or TRXs may also be partially reused, or only respective subsets can be active for transmissions and receptions when FD communication is enabled.

When a UE receives signals/channels from a gNB in a full-duplex slot, the receptions may be scheduled in a DL subband of the full-duplex slot. When full-duplex operation at the gNB uses DL slots for scheduling transmissions from the UE using full-duplex transmission and reception at the gNB, there may be one or multiple, such as two, DL subbands in the full-duplex slot. When a UE is scheduled to transmit in a full-duplex slot, the transmission may be scheduled in an UL subband of the full-duplex slot. When full-duplex operation at the gNB uses UL slots for purpose of scheduling transmissions to UEs using full-duplex transmission and reception at the gNB, there may be one or multiple, such as two, UL subbands in the full-duplex slot. Full-duplex operation using an UL subband or a DL subband may be referred to as Subband-Full-Duplex (SBFD).

For example, when full-duplex operation at the gNB uses a DL or F slot or symbol for scheduling transmissions from the UE using full-duplex transmission and reception at the gNB, there may be one DL subband on the full-duplex slot or symbol and one UL subband of the full-duplex slot or symbol in the NR carrier. A frequency-domain configuration of the DL and UL subbands may then be referred to as ‘DU’ or ‘UD’, respectively, depending on whether the UL subband is configured/indicated in the upper or the lower part of the NR carrier. In another example, when full-duplex operation at the gNB uses a DL or F slot or symbol for scheduling transmissions from the UE using full-duplex transmission and reception at the gNB, there may be two, DL subbands and one UL subband on the full-duplex slot or symbol. A frequency-domain configuration of the DL and UL subbands may then be referred to as ‘DUD’ when the UL subband is configured/indicated in a part of the NR carrier and the DL subbands are configured/indicated at the edges of the NR carrier, respectively.

In the following, for brevity, full-duplex slots/symbols and SBFD slots/symbols may be jointly referred to as SBFD slots/symbol and non-full-duplex slots/symbols and normal DL or UL slot/symbols may be referred to as non-SBFD slots/symbols.

Instead of using a single carrier, it is also possible to use different component carriers (CCs) for receptions and transmissions by a UE. For example, receptions by a UE can occur on a first CC and transmissions by the UE occur on a second CC having a small, including zero, frequency separation from the first CC. For example, when carrier-aggregation based full-duplex operation is used, an SBFD subband may correspond to a component carrier or a part of a component carrier or an SBFD subband may be allocated using parts of multiple component carriers.

In one example, the gNB may support full-duplex operation, e.g., support simultaneous DL transmission to a UE in an SBFD DL subband and UL reception from a UE in an SBFD UL subband on an SBFD slot or symbol. In one example, the gNB-side may support full-duplex operation using multiple TRPs, e.g., TRP A may be used for simultaneous DL transmission to a UE and TRP B for UL reception from a UE on an SBFD slot or symbol.

Full-duplex operation may be supported by a half-duplex UE or by a full-duplex UE. A UE operating in half-duplex mode can transmit or receive but cannot simultaneously transmit and receive on a same symbol. A UE operating in full-duplex mode can simultaneously transmit and receive on a same symbol. For example, a UE can operate in full-duplex mode on a single NR carrier or based on the use of intra-band or inter-band carrier aggregation.

For example, when the UE is capable of full-duplex operation, SBFD operation based on overlapping or non-overlapping subbands or using one or multiple UE antenna panels may be supported by the UE. In one example, an FR2-1 UE may support simultaneous transmission to the gNB and reception from the gNB on a same time-domain resource, e.g., symbol or slot. The UE capable of full-duplex operation may then be configured, scheduled, assigned or indicated with DL receptions from the gNB in an SBFD DL subband on a same SBFD symbol where the UE is configured, scheduled, assigned or indicated for UL transmissions to the gNB on an SBFD UL subband. In one example, the DL receptions by a UE may use a first UE antenna panel while the UL transmissions from the UE may use a second UE antenna panel on the same SBFD symbol/slot. For example, UE-side self-interference cancellation capability may be supported in the UE by one or a combination of techniques as described in the gNB case, e.g., based on spatial isolation provided by the UE antennas or UE antenna panels, or based on analog and/or digital equalization, or filtering. In one example, DL receptions by the UE in a first frequency channel, band or frequency range, may use a TRX of a UE antenna or UE antenna panel while the UL transmissions from the UE in a second frequency channel, band or frequency range may use the TRX on a same SBFD symbol/slot. For example, when the UE is capable of full-duplex operation based on the use of carrier aggregation, simultaneous DL reception from the gNB and UL transmission to the gNB on a same symbol may occur on different component carriers.

In the following, for brevity, a UE operating in half-duplex mode but supporting a number of enhancements for gNB-side full-duplex operation may be referred to as SBFD-aware UE. For example, the SBFD-aware UE may support time-domain or frequency-domain resource allocation enhancements to improve the UL coverage or throughput or spectral efficiency when operating on a serving cell with gNB-side SBFD support.

In the following, for brevity, a UE operating in full-duplex mode may be referred to as SBFD-capable UE, or as full-duplex capable UE, or as a full-duplex UE. A full-duplex UE may support a number of enhancements for gNB-side full-duplex operation. For example, the SBFD-capable UE may support time-domain or frequency-domain resource allocation enhancements to improve the UL coverage or throughput or spectral efficiency when operating on a serving cell.

In one example, a gNB may operate in full-duplex (or SBFD) mode and a UE operates in half-duplex mode. In one example, a gNB may operate in full-duplex (or SBFD) mode and a UE operates in full-duplex (or SBFD) mode. In one example, gNB-side support of full-duplex (or SBFD) operation is based on multiple TRPs wherein a TRP may operate in half-duplex mode, and a UE operates in full-duplex mode.

In one example, a TDD serving cell supports a mix of full-duplex and half-duplex UEs. For example, UE1 supports full-duplex operation and UE2 supports half-duplex operation. The UE1 can transmit and receive simultaneously in a slot or symbol when configured, scheduled, assigned or indicated by the gNB. UE2 can either transmit or receive in a slot or symbol while simultaneous DL reception by UE2 and UL transmission from UE2 cannot occur on the same slot or symbol.

FD transmission/reception is not limited to gNBs, TRPs, or UEs, but can also be used for other types of wireless nodes such as relay or repeater nodes.

As this disclosure recognizes, there is a need for full duplex operation to overcome several challenges in order to be functional in actual deployments. When using overlapping frequency resources, received signals are subject to co-channel CLI and self-interference (SI). CLI and self-interference cancellation (SIC) methods include passive methods that rely on isolation between transmit and receive antennas, active methods that utilize RF or digital signal processing, and hybrid methods that use a combination of active and passive methods. Filtering and interference cancellation may be implemented in RF, baseband (BB), or in both RF and BB. While mitigating co-channel CLI may require large complexity at a receiver, it is feasible within current technological limits. Another aspect of FD operation is the mitigation of adjacent channel CLI because in several cellular band allocations, different operators have adjacent spectrum.

Throughout this disclosure, the term ‘full-duplex’ (FD) is used as a short form for a full-duplex operation in a wireless system. The terms ‘cross-division-duplex’ (XDD), ‘full-duplex’ (FD) and ‘subband-full-duplex’ (SBFD) may be used interchangeably in the disclosure.

Full-duplex operation in NR can improve spectral efficiency, link robustness, capacity, and latency of UL transmissions. In an NR TDD system, transmissions from a UE may be limited by fewer available transmission opportunities than receptions by the UE. For example, for NR TDD with SCS=30 kHz, DDDU (2 msec), DDDSU (2.5 msec), or DDDDDDDSUU (5 msec), the UL-DL configurations allow for an DL:UL ratio from 3:1 to 4:1. Any transmission from the UE can only occur in a limited number of UL slots, for example every 2, 2.5, or 5 msec, respectively.

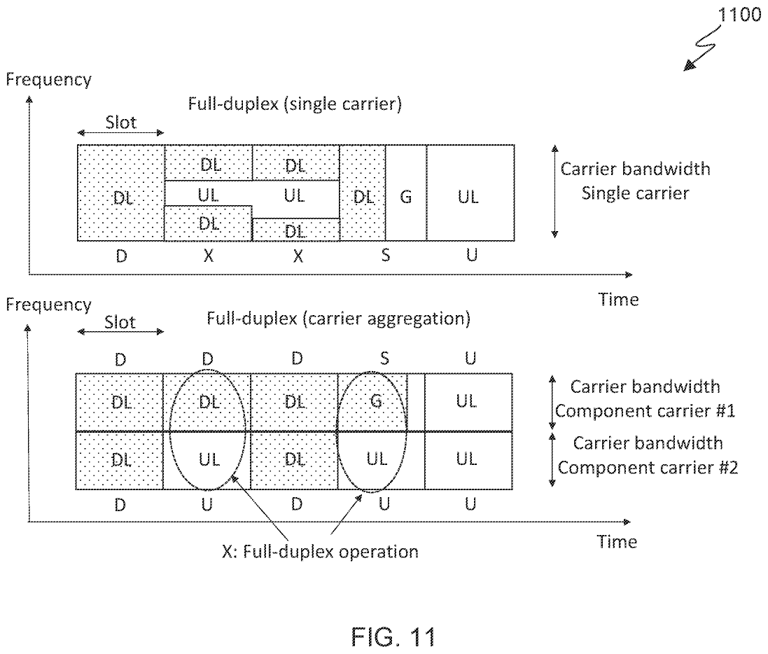

FIG. 11 illustrates example UL-DL frame configurations in a full-duplex communications system 1100 according to embodiments of the disclosure. The embodiment of the UL-DL frame configurations in a full-duplex communications system 1100 illustrated in FIG. 11 is for illustration only. FIG. 11 does not limit the scope of this disclosure to any particular implementation of the UL-DL frame configuration in a TDD communication system 1100.

FIG. 11 illustrates two example full-duplex configurations using single-carrier and carrier aggregation UL-DL frame configurations according to embodiments of the present disclosure.

For a single carrier TDD configuration with full-duplex enabled, slots denoted as X are full-duplex or XDD slots. Both DL and UL transmissions can be scheduled in FD or XDD slots for at least one or more symbols. The term FD or XDD slot is used to refer to a slot where UEs can simultaneously receive and transmit in at least one or more symbols of the slot if scheduled or assigned radio resources by the base station. A half-duplex UE cannot transmit and receive simultaneously in an FD or XDD slot or on a symbol of a FD slot. When a half-duplex UE is configured for transmission in symbols of a FD or XDD slot, another UE can be configured for reception in the symbols of the FD or XDD slot. A full-duplex UE can transmit and receive simultaneously in the symbols of a FD or XDD slot, possibly in presence of other UEs scheduled or assigned resources for either DL or UL in the symbols of the FD or XDD slot. Transmissions by a UE in a first FD or XDD slot can use same or different frequency-domain resources than in a second FD or XDD slot, wherein the resources can differ in bandwidth, a first RB, or a location of the center carrier.

For a carrier aggregation TDD configuration with full-duplex enabled, a UE receives in a slot on CC #1 and transmits in at least one or more symbols of the slot on CC #2. In addition to D slots used only for transmissions/receptions by a gNB/UE, U slots used only for receptions/transmissions by the gNB/UE, and S slots for also supporting DL-UL switching, FD or XDD slots with both transmissions/receptions by a gNB or a UE that occur on same time-domain resources, such as slots or symbols, are labeled by X. For the example of TDD with SCS=30 kHz, single carrier, and UL-DL allocation DXXSU (2.5 msec), the second and third slots allow for FD operation. UL transmissions can also occur in a last slot (U) where the full UL transmission bandwidth is available. FD or XDD slots or symbol assignments over a period of time and/or number of slots can be indicated by a DCI format in a PDCCH reception and can then vary per unit of the time period, or can be indicated by higher layer signaling, such as via a MAC CE or RRC.

Various embodiments of the present disclosure recognize several issues when considering UL transmissions and/or DL receptions in a full-duplex capable wireless communication system. For example, this disclosure recognizes that in NR TDD networks with support for full-duplex or SBFD operation, DL and/or UL channel or signal configuration and indication of the DL and/or UL transmission direction by the gNB and the determination of the DL and/or UL transmission direction by the UE become significantly more challenging due to the needs of cross-link-interference (CLI) management and self-interference cancellation (SIC) at the gNB during system operation.

This disclosure further recognizes that, for example, in NR TDD networks with support for full-duplex or XDD operation, a guard band between an SBFD DL subband and an SBFD UL subband may be required by the gNB to avoid undesired inter-subband CLI and DL-UL self-interference levels in a gNB-side SIC implementations. For example, the use of time-domain digital SIC by the gNB may result in a different number of guard RBs than when frequency-domain analog or digital SIC is used by the gNB.

This disclosure also recognizes that, for example, when a guard band is fixed or the same size, e.g., the number of RBs of a guard band is fixed by system operating specifications as a function of the RF band combination associated with a given SBFD DL and/or UL subband configuration, the resulting cell and UE throughput in SBFD deployments may be reduced. This is because the radio resources corresponding to the guard band(s) may then be reserved and cannot be scheduled by the gNB. Also, guard band(s) would then be present even if neighbor cells on the NR channel do not schedule the SBFD UL subband in an SBFD slot/symbol in the slot or symbol. In consequence, un-schedulable RBs that reduce the cell and/or UE throughput would exist even if the presence of the guard band due to CLI management is not necessary in the SBFD slot/symbol.

This disclosure recognizes that a gNB may create guard band(s) implicitly through its DL and/or UL scheduling decisions. The gNB can schedule or configure the DL or UL signals/channels and create a guard band by not assigning a desired number of RBs between an SBFD UL subband and an SBFD DL subband. A UE follows gNB DL/UL scheduling decisions, e.g., indicated by a DCI format or by higher layer information. In consequence, the UE then does not know about the existence of guard band. When no explicit guard band configuration is provided by the gNB to a UE, the gNB implementation can benefit from increased scheduling flexibility. For example, the gNB may schedule UL and/or DL signals/channels from/to UEs in the SBFD slot or symbol when operating in presence of large spatial isolation between co-scheduled UEs in a serving cells using a small guard band size or no guard band. In cases where only small spatial isolation is possible between co-scheduled UEs in the SBFD slot or symbol, a large guard band size may be used by the gNB. The gNB may use different a different number of RBs including none at all in different full-duplex time-domain resources, i.e., slots or symbols. However, the UE operating in the TDD serving cell providing SBFD enhancements to improve gNB-side full-duplex operation and not knowing the presence or size of a guard band can then not implement advanced Rx-side or Tx-side processing such as baseband (BB) filtering to improve and control or adjust receptions and transmissions with respect to EVM in the allocation bandwidth, the ACLR, the SEM or in-band emissions. In consequence, the achievable DL and/or UL link budgets for UEs may then be reduced when compared to SBFD-aware UEs knowing the presence and size of a guard band implementing Rx-side or Tx-side filtering. A reason is that advanced Rx-side filtering can increase SBFD inter-subband in-band interference rejection levels during DL reception and Tx-side filtering can reduce SBFD inter-subband in-band blocking of co-scheduled UEs in the SBFD slot/symbol.

This disclosure also recognizes that when a number and a frequency-domain location of the RBs or SCs used as guard band(s) between an SBFD UL and DL subband are known to a UE, then the UE implementation can benefit from additional UE Rx and Tx-side BB filtering on the allocation BW of DL or UL signals or channels in the SBFD DL and UL subbands, respectively. For example, in an SBFD slot or symbol with a configured or indicated SBFD UL subband, the UE operational bandwidth can be scaled down to the size of the SBFD UL subband instead of the UE active UL BWP in a normal UL slot/symbol. In consequence, several UE modem functional blocks such as D/A converter and BB may use a lower voltage and/or a lower clock rate due to less data samples for processing. This is beneficial for the UE Tx PA regime and reduces UE power consumption. The knowledge by the UE of the presence, or size, or frequency-domain location of a guard band may also be exploited by the UE implementation when adjusting BB filtering of the Tx-side waveform in the allocation BW of a PUSCH, a PUCCH, an SRS or a random access preamble transmission. This is because guard band RB(s) may be treated as excess bandwidth and can then absorb UL spectral products through the frequency-domain waveform shaping in the filtering solution. However, explicitly configuring or indicating a number of guard band RBs or SCs to a UE however may be prohibitive in terms of the resulting signaling overhead. For example, flexibility during SBFD operation may be required to configure or indicate a guard band on an SBFD symbol with symbol-level granularity and dynamic adjustments during full-duplex system operation.

This disclosure further recognizes that guard bands typically need to be considered in conjunction with SBFD DL and/or UL subbands in the NR carrier BW. In one approach, when the frequency-domain occupancy of the SBFD UL subband is explicitly configured for the UE, the UE may use the knowledge of the DL and/or UL NR carrier BW parameters and the configured or indicated SBFD UL subband size and frequency-domain occupancy to determine the remaining RBs of an NR carrier BW in an SBFD slot or symbol as DL subbands. This approach has the drawback that the UE then cannot know if a guard band was used by the gNB when scheduling or assigning the UL transmissions and/or DL receptions. One reason is that the UE cannot implement advanced Tx or Rx-side filtering solutions for UL transmission or DL reception on the SBFD UL or DL subbands. Another drawback is that the UE may assume that all the remaining RBs in the NR carrier bandwidth, after removing RBs configured or indicated as SBFD UL subband on the SBFD symbol or slot, with respect to the active DL BWP belong to SBFD DL subband(s). This is undesirable because the gNB may need to separately, or independently control and adjust the assignment of a frequency location, such as the number of RBs or the starting RBs, of the SBFD DL subband(s) for a UE with respect to the UE BWP and/or with respect to the NR carrier BW.

Therefore, as this disclosure addresses in various embodiments, there is a need to control or adjust the number of guard band RBs or SCs and the frequency-domain occupancy of the guard band(s) during SBFD operation. Additionally, as this disclosure also addresses, there is a need to control or adjust the SBFD DL subband allocation on a symbol/slot during SBFD operation. As addressed by embodiments of this disclosure, there is another need for efficient signaling support to reduce the DL signaling overhead in a TDD cell supporting full-duplex operation when SBFD subbands of different subband types such as an UL subband, an DL subband, or a guard band are configured or indicated to a UE.

In another example, when scheduling or assigning transmissions and receptions using the SBFD subband(s), it is desirable that the introduction of SBFD operation in a TDD cell does not result in a hard UL-DL resource split in the TDD cell. When DL receptions by a UE can only occur inside an SBFD DL subband, or when UL transmissions from a UE can only occur inside an SBFD UL subband, hard UL-DL resource partitioning ensues. DL peak and cell aggregate throughput and the DL spectral efficiency (SE) are reduced because UL radio resources are then not schedulable or assignable for DL receptions by a UE. It may be expected that the gNB configured frequency-domain occupancy of an SBFD UL subband in the gNB channel BW is first selected according to deployment needs. For example, the SBFD UL subband configuration may depend on the operator band segment in the NR band. The frequency-domain location and size of the SBFD UL subband may depend on the gNB-side SBFD SIC implementation and capabilities. For example, for a Wide-area (WA) or Medium-range (MR) base station class implementation, it may be expected that the gNB-side SIC implementation and capabilities may restrict the possibility of scheduling or assigning the UL transmissions from UEs outside a configured SBFD UL subband due to a need for analog and/or digital filtering. However, the gNB scheduler may be able to schedule or assign DL receptions by UEs using the SBFD UL subband for DL transmissions from the gNB because no SIC is needed when a symbol or slot is used for DL-only receptions by UEs.

In consequence, to avoid a reduced cell or UE throughput and spectral efficiency in a TDD serving cell supporting SBFD operation resulting from semi-static UL-DL resource split, it is desirable that an SBFD slot or symbol may be used for scheduling or assigning DL receptions by UEs. UE-side advanced Tx-side and/or Rx-side filtering may depend on several factors such as the frequency-domain location(s) and size(s) of the SBFD subbands on a symbol or slot or the UE DL BWP and UL BWP. Filter re-configuration and switching time must be accounted for. The ability of the gNB scheduler to schedule or assign an SBFD UL subband for DL receptions by UEs may depend on inter-cell intra-subband CLI levels.

Therefore, as addressed by embodiments of this disclosure, there is a need to control or adjust the DL and/or UL transmission directions of SBFD subband(s) in a TDD cell supporting full-duplex operation while allowing for reduced UE modem implementation complexity.

This disclosure addresses the above issues and provides additional aspects for supporting transmissions and receptions for a UE in a cell supporting SBFD operation, and provides solutions as elaborated below. The present disclosure considers methods and solutions for a UE to determine an SBFD guard band based on an SBFD UL subband and an SBFD DL subband, methods and solutions for a UE to determine an SBFD DL subband based on an SBFD guard band and an SBFD UL subband, and methods and solutions for a UE to determine an SBFD subband based on a reference symbol/slot and/or a reference UE BWP.

Embodiments of this disclosure are summarized in the following and are fully elaborated further below. Combinations of the embodiments are also applicable, but they are not described in detail for brevity. In embodiments, SBFD guard band(s) may be determined from SBFD DL and UL subbands for same/separate symbol cases. In embodiments, SBFD DL subband(s) may be determined from SBFD UL subband and guard band(s) for same/separate symbol cases. In more embodiments, frequency-domain limit values may be utilized to determine start and/or end of SBFD subband with respect to NR carrier BW. In some embodiments, frequency-domain adjustment value for min/max/default size of an SBFD subband may be used. In other embodiments, a UE or gNB may use a reference BWP to determine SBFD subbands on a symbol. In embodiments, this disclosure provides hard/soft configurations for SBFD UL subband. In yet more embodiments, this disclosure provides SBFD subband configuration in RRC_IDLE/INACTIVE as a subset of SBFD subband configuration in RRC_CONNECTED.

In one embodiment, a UE (e.g., 111, 112, 113, etc.) is provided with information for an SBFD DL subband configuration in an SBFD slot or symbol. For example, an SBFD DL subband configuration may be indicated or assigned by the gNB (e.g., 101, 102, 103, etc.) to the UE for one or two SBFD DL subbands on a symbol or slot using higher layer signaling. The UE is provided with information for an SBFD UL subband configuration in an SBFD slot or symbol. For example, an SBFD UL subband configuration may be indicated or assigned by the gNB to the UE using higher layer signaling. The UE determines the frequency-domain location and size of an SBFD guard band in an SBFD slot or symbol as RBs which are not explicitly configured, indicated or assigned as SBFD DL and/or UL subbands in the SBFD slot or symbol based on information provided to the UE for an NR carrier BW and/or based on a UE bandwidth part (BWP) configuration.

For example, the UE is provided with information for an SBFD UL subband configuration in one or more SBFD symbols by higher layer signaling. For example, a frequency-domain location and a size or a frequency-domain occupancy of the SBFD UL subband may be provided to the UE by means of indicating or assigning a start RB and an allocation bandwidth, or based on a resource indicator value (RIV), or a number of RBs, or a bitmap. An SBFD UL subband configuration may be provided to the UE with respect to a common resource block (CRB) grid. An SBFD UL subband configuration may be provided to the UE with respect to a UE BWP configuration, e.g., excluding resource blocks (RBs) in an NR carrier BW that are not within a configured or an active UE BWP. An SBFD UL subband configuration may be provided based on a reference RB and/or based on a reference SCS. The UE is provided with information for an SBFD DL subband configuration in an SBFD slot or symbol by higher layer signaling. For example, a frequency-domain location and a size or a frequency-domain occupancy of an SBFD DL subband may be provided to the UE by means of indicating or assigning a start RB and an allocation bandwidth, or an RIV value, or a number of RBs, or a bitmap, separately from a configuration provided to the UE for an SBFD UL subband. An SBFD DL subband configuration may be provided to the UE with respect to a CRB grid, or with respect to a UE BWP configuration. An SBFD DL subband configuration may be provided based on an indicated reference RB and/or based on a reference SCS. There may be multiple SBFD DL subband configurations in an SBFD symbol or slot. If multiple SBFD DL subband configurations are provided for an SBFD symbol or slot, the SBFD DL subbands may be non-contiguous. For example, two SBFD DL subband configurations may be provided to the UE for an SBFD symbol by higher layers. A same SBFD DL subband configuration or a same SBFD UL subband configuration may be provided for multiple symbols or slots, or different symbols or slots may be indicated or assigned separate SBFD DL subband and/or SBFD UL subband configurations, respectively.

The UE determines an SBFD guard band using the provided SBFD UL subband and DL subband configurations by assuming that RBs that are not part of the SBFD UL subband configuration and that are not part of the SBFD DL subband configuration provided by higher layer signaling over a reference bandwidth, are SBFD guard band RBs or SCs. For example, the reference bandwidth may correspond to the NR DL or UL carrier bandwidth, or the reference bandwidth may correspond to a configured or an active UE DL BWP or UE UL BWP on a TDD cell. When a UE is scheduled or assigned DL reception or UL transmission in an SBFD guard band, the UE may assume that no DL reception from the gNB or UL transmission to the gNB in an RB corresponding to an SBFD guard band may occur.

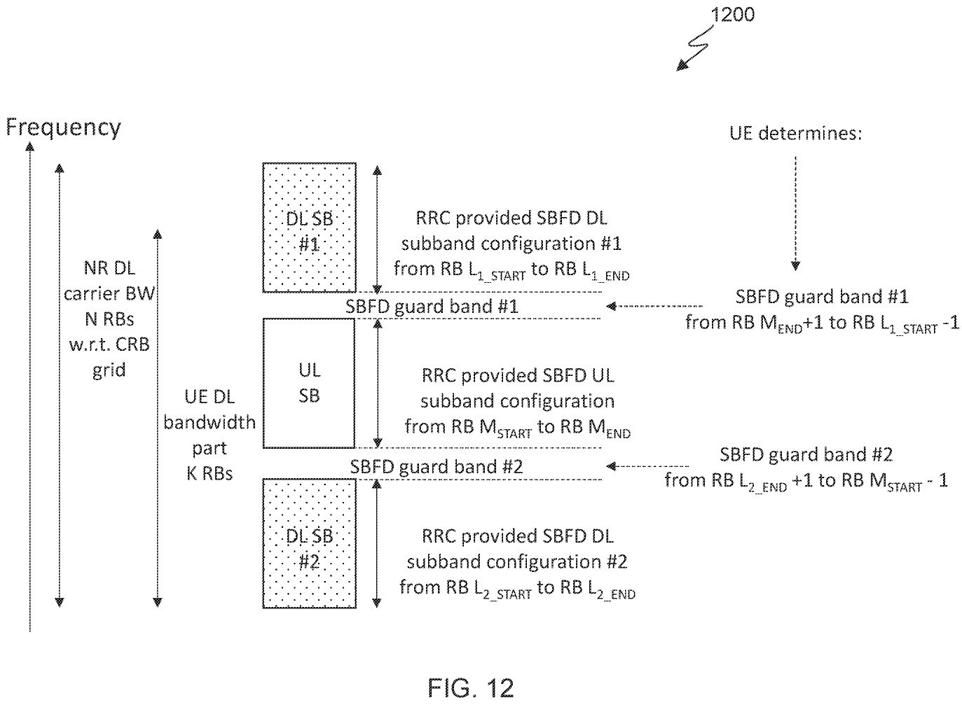

FIG. 12 illustrates an example for guard band determination based on SBFD UL and DL subbands in a full-duplex communications system 1200 according to the embodiments of the disclosure. The embodiment of the guard band determination in a full-duplex communication system 1200 illustrated in FIG. 12 is for illustration only, and may be implemented, for example by a wireless network 100 having one or more gNBs (e.g., 101, 102, 103, etc.) and one or more UEs (e.g., 111, 112, 113, etc.). FIG. 12 is not intended to limit the scope of this disclosure to any particular implementation of the guard band determination in a full-duplex communications system 1200.

An example SBFD configuration in a full-duplex communication system is shown in FIG. 12. Full-duplex operation is configured for NR band n78 using an SCS=30 kHz. Here, an NR DL carrier BW is N=273 RBs numbered from 0 to 272. A UE DL BWP of size K=200 RBs which correspond to RBs 0-199 of the NR DL carrier BW is configured for a UE. The UE is indicated an SBFD UL subband configuration on RBs M_{START}=100 to M_{END}=150 on an SBFD symbol by higher layer signaling. The UE is indicated two SBFD DL subbands by higher layer signaling. SBFD DL subband #2 is located on RBs L_{2_START}=10 to L_{2_END}=95 and SBFD DL subband #1 is located on RBs L_{1_START}=155 to L_{1_END}=272 with respect to the NR DL carrier BW, e.g., the CRB grid. Based on the NR DL carrier BW and the SBFD subband configurations, the UE determines the SBFD guard bands to include the RBs from L_{2_END}+1=96 to M_{START_1}=99 and from RBs M_{END}+1=151 to L_{1_START}−1=154. The UE may assume that no DL receptions or UL transmissions using the RBs of the SBFD guard bands occur. Using a configured or active UE DL BWP of size K=200 RBs, the UE determines the SBFD guard bands to be comprised by the DL BWP. The UE determines that DL reception using the SBFD DL subband #2 can occur in the SBFD DL subband #2 because it is fully comprised in the active DL BWP of the UE. The UE determines that DL reception using the SBFD DL subband #1 can occur in RBs 155-199 of the SBFD DL subband #1, because RBs 200-272 are not included in the active DL BWP of the UE.

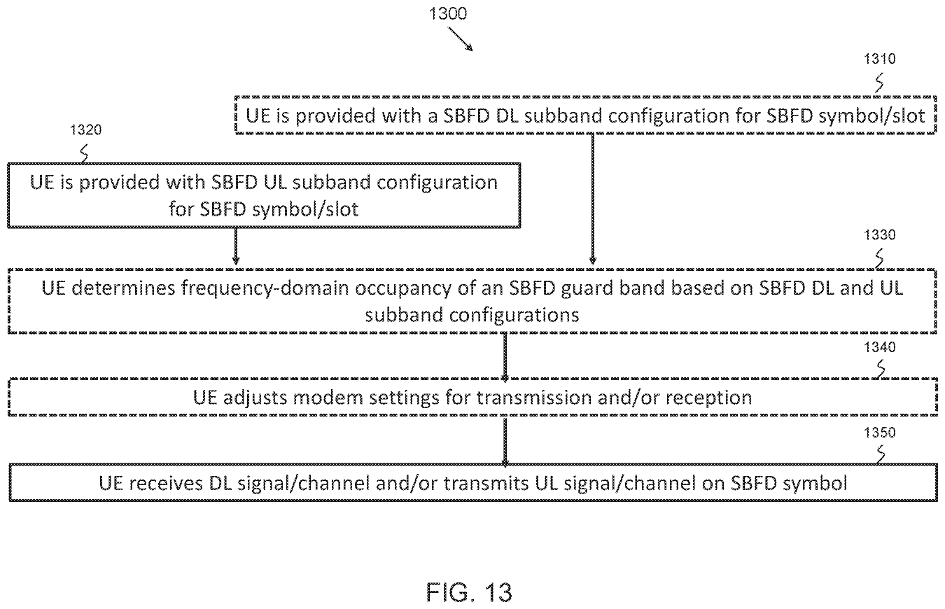

With reference to FIG. 13, an example UE processing flowchart for guard band determination based on SBFD DL and UL subband configurations is illustrated. The UE processing flowchart 1300 may be implemented, for example, by a UE 111, 112, or 113, etc., in a wireless network system, e.g., 100 to facilitate guard band determination.

In embodiments, the UE is provided with an SBFD DL subband configuration for an SBFD symbol or slot, 1310. For example, one or two SBFD DL subband configurations, e.g., for an SBFD configuration of type ‘DU’ or ‘UD’, or for an SBFD configuration of type ‘DUD’, respectively, may be provided to the UE. The UE is provided with an SBFD UL subband configuration for an SBFD symbol or slot, 1320. For example, the SBFD DL and UL subband configurations, 1310 and 1320, may be indicated with reference to PRB numbering of the CRB grid or using equivalent reference RB numbering. The UE determines a frequency-domain occupancy, e.g., a set of RBs, for an SBFD guard band(s) based on the SBFD DL and UL subband configurations with respect to the reference RB numbering, 1330. For example, the UE may determine a frequency-domain occupancy, e.g., location(s) and set(s) of RBs, for one or two SBFD guard bands. The UE may determine that only a part of an SBFD DL subband, or of an SBFD UL subband or of an SBFD guard band are applicable for DL reception and/or UL transmission with respect to a configured or an active UE BWP. For example, the UE may determine that an SBFD guard band is located partially or fully outside of a configured or an active UE BWP and some or all RBs of an SBFD guard band are not applicable to its transmission and/or reception settings. Based on the frequency-domain occupancies of the SBFD subband(s) and/or guard band(s), the UE adjusts its modem settings for transmission and/or reception, 1340. For example, the UE may load into memory and/or apply Rx and/or Tx filter parameters for further receptions and/or transmissions based on the SBFD subband(s). For example, a UE may configure a number of RBs or a set of RBs as not allowed for DL receptions and/or not allowed for UL transmissions even if scheduled or assigned by DCI or higher layer signaling. The UE applies the adjusted modem settings and if scheduled or assigned DL receptions and/or UL transmissions, receives and/or transmits using the adjusted modem settings, 1350.

In embodiments of this disclosure, one motivation is that signaling overhead for SBFD configuration(s) and subband assignment(s) is reduced. When the frequency-domain occupancy of an SBFD DL subband and an SBFD UL subband is provided to the UE for an SBFD symbol/slot, the frequency-domain occupancy of an SBFD guard bands can then be determined by the UE. The frequency-domain occupancies, e.g., sizes and/or locations, for SBFD DL and UL subbands can be controlled separately by the gNB in the NR carrier BW. The UE is informed of the presence and the frequency-domain occupancy of an SBFD guard band. The UE can benefit from the use of advanced Tx-side or Rx-side filtering during transmissions and receptions using the SBFD subbands in the TDD cell supporting full-duplex operation which can increase radio range and link robustness.

In embodiments, when the UE determines the frequency-domain occupancy of an SBFD guard band based on an SBFD DL subband configuration and based on an SBFD UL subband configuration, the SBFD DL and UL subband configuration(s) may be provided for a same set or for separate sets of symbols/slots, respectively.

For example, an SBFD DL subband configuration and an SBFD UL subband configuration may both be provided for a same set of symbols/slots. The UE determines an SBFD guard band for the same set of symbols/slots provided by the SBFD subband configurations. When the same frequency-domain occupancies apply to an SBFD DL subband and to an SBFD UL subband on a symbol from the set of symbols/slots, the UE then determines a same frequency-domain occupancy for the SBFD guard band on the symbol.

For example, an SBFD DL subband configuration and an SBFD UL subband configuration may be provided for different sets of symbols/slots where the different sets can partially overlap or where they do not overlap. An SBFD DL subband configuration is provided to the UE for a first set of symbols/slots. An SBFD UL subband configuration is provided to the UE for a second set of symbols/slots. The UE determines an SBFD guard band for a third set of symbols/slots. The UE determines a frequency-domain occupancy of an SBFD guard band for a symbol from the third set of symbols/slots based on an SBFD DL subband configuration and based on an SBFD UL subband configuration when the symbol from the third set is comprised in both the first and the second sets of symbols/slots.

For example, an SBFD DL subband configuration and an SBFD UL subband configuration may be provided for a same set or for different sets of symbols/slots where the different sets can partially overlap or not overlap. The UE determines an SBFD guard band on a symbol using an SBFD DL subband configuration and/or an SBFD UL subband configuration based on one or more reference symbol(s) or slot(s). An SBFD DL subband configuration is provided to the UE for a first set of symbols/slots. An SBFD UL subband configuration is provided to the UE for a second set of symbols/slots. The UE determines an SBFD guard band for a third set of symbols/slots. The UE determines a frequency-domain occupancy of an SBFD guard band for a symbol from the third set of symbols/slots based on a first reference symbol or slot with reference to a symbol or slot from the first set of symbols/slots provided for an SBFD DL subband configuration and/or based on a second reference symbol or slot with reference to a symbol or slot from the second set of symbols/slots provided for an SBFD UL subband configuration. The first reference symbol/slot and the second reference symbol/slot may be the same or different. A first reference symbol/slot and/or a second reference symbol/slot may be configured and/or indicated to the UE based on DCI signaling, MAC-CE signaling or by RRC signaling, or correspond to a fixed value or be tabulated and provided by system operating specifications. Only one of the first or the second reference symbol/slot may be configured and/or indicated to the UE while the other reference symbol/slot may be a fixed or a tabulated value. Only one reference symbol/slot may be provided to the UE to determine the frequency-domain occupancy of an SBFD guard band on a symbol from the third set of symbols/slots. For example, the UE may determine the SBFD guard band on a symbol from the third set of symbols/slots based on an SBFD UL subband configuration on the same symbol in the second set of symbols/slots but using an SBFD DL subband configuration on a reference symbol/slot from the first set of slots/symbols. The same principle may be applied when a reference symbol/slot is used from the second set of slots/symbols for the SBFD UL subband and the SBFD guard band on a symbol that is determined by the UE based on an SBFD DL subband configuration for the same symbol.

For example, a relative symbol or slot offset value may be indicated for a reference symbol/slot with respect to an SBFD DL subband configuration or with respect to an SBFD UL subband configuration. The UE may determine a frequency-occupancy for an SBFD guard band in a symbol or in a slot k based on an SBFD DL and/or UL subband configuration provided for an earlier symbol or slot k−k_{ref} with k_{ref}>0, possibly under a side conditions that k_{ref} is equal to or larger than a minimum value, such as k_{ref,min}=4, to provide a minimum application or processing delay to the UE.

An example SBFD configuration in a full-duplex communication system is considered for illustration purposes. Full-duplex operation is configured for NR band n78 using an SCS=30 kHz. Here, an NR DL carrier BW is N=273 RBs numbered from 0 to 272. A UE DL BWP of size K=200 RBs, which corresponds to RBs 0-199 of the NR DL carrier BW, is configured for a UE. The UE is indicated an SBFD UL subband allocation on RBs M_{START}=100 to M_{END}=150 on an SBFD symbol by higher layer signaling. The UE is indicated two SBFD DL subbands by higher layer signaling. SBFD DL subband #2 is located on RBs L_{2_START}=10 to L_{2_END}=95 and SBFD DL subband #1 is located on RBs L_{1_START}=155 to L_{1_END}=272 with respect to the NR DL carrier BW, e.g., the CRB grid. The indicated SBFD DL subband configuration and the SBFD UL subband configuration are same on all symbols in a slot for the second and third slot of a DXXSU UL-DL frame configuration where ‘X’ denotes a slot supporting full-duplex operation in the TDD cell. In some embodiments, without limiting the scope of the principles of this example, it may be assumed that the first slot operates in DL-only mode, the last slot operates in UL-only mode, and the fourth slot ‘S’ operates a DL part in DL-only mode for first symbols and/or an UL part in UL-only mode for second symbols. A reference symbol/slot with respect to the SBFD DL subband configuration is provided to the UE to determine an SBFD guard band on a slot/symbol. For example, the last symbol of the last full-duplex slot in a preceding UL-DL frame period n configured with an SBFD DL subband is the reference symbol/slot for SBFD guard band determination in a later UL-DL frame period. Based on the NR DL carrier BW and the SBFD UL subband configuration on a symbol, the UE determines the SBFD guard bands on the same symbol in UL-DL frame period n+1 to include the RBs from L_{2_END}+1=96 to M_{START}−1=99 and from RBs M_{END}+1=151 to L_{1_START}−1=154 based on the reference symbol/slot. Using a configured or active DL BWP of size K=200 RBs, the UE determines the SBFD guard bands within the DL BWP. A re-configuration of the SBFD DL subband configuration is provided to the UE by higher layers in a PDSCH received in UL-DL frame period n or earlier. A modified SBFD DL subband configuration reduces the size of the SBFD DL subband #1 to an indicated frequency-domain occupancy on RBs from L_{1_START}=158 to L_{1_END}=222. Accounting for sufficient activation delay of the new SBFD subband configuration, the new SBFD DL subband configuration #1 is applied starting from the first applicable slot in UL-DL frame period n+2. Based on the NR DL carrier BW and the SBFD UL subband configuration on a symbol, the UE determines the SBFD guard bands in UL-DL frame period n+2 to include the RBs from L_{2_END}+1=96 to M_{START}−1=99 and from RBs M_{END}+1=151 to L_{1_START}−1=154 based on the reference symbol/slot from UL-DL frame period n+1 and then determines the SBFD guard bands in UL-DL frame period n+3 to include the RBs from L_{2_END}+1=96 to M_{START_1}=99 and from RBs M_{END}+1=151 to L_{1_START}−1=157 based on the reference symbol/slot from UL-DL frame period n+2.

In various embodiments, similar principles can be applied when: (a) a reference symbol/slot to determine an SBFD guard band on a slot/symbol is provided, indicated, or defined with reference to a symbol/slot for an SBFD UL subband configuration, (b) when a first reference symbol/slot is provided, indicated, or defined with respect to an SBFD DL subband configuration and a second reference symbol/slot is provided, indicated, or defined with respect to an SBFD UL subband configuration where the first and/or second reference symbol/slot may be a same or may be different.

A benefit of using a provided, an indicated, or a defined absolute or relative reference symbol/slot to determine an SBFD guard band for another symbol or slot is that the UE modem design can account for sufficient application and processing delay, e.g., for loading or when changing filtering coefficients or when applying updated BB or RF modem configurations. Another benefit is that the determination of an SBFD guard band on a symbol by the UE does not necessitate provision of both SBFD DL and UL subbands on the same symbol. An SBFD UL subband configuration may be provided for a different set of symbols/slots than an SBFD DL subband configuration which increases gNB-side flexibility for allocation of DL receptions and/or UL transmissions to a UE using full-duplex slots.

In further embodiments of this disclosure, the UE is provided with information for an SBFD guard band configuration in an SBFD slot or symbol. For example, an SBFD guard band configuration may be indicated or assigned by the gNB to the UE for one or two SBFD guard band(s) on a symbol or slot using higher layer signaling. The UE is provided with information for an SBFD UL subband configuration in an SBFD slot or symbol. For example, an SBFD UL subband configuration may be indicated or assigned by the gNB to the UE using higher layer signaling. The UE determines the frequency-domain location and size of an SBFD DL subband in an SBFD slot or symbol as RBs which are not explicitly configured, indicated, or assigned as SBFD guard band(s) and/or UL subband(s) in the SBFD slot or symbol based on information provided to the UE for an NR carrier BW and/or based on a UE bandwidth part (BWP) configuration.

For example, the UE is provided with information for an SBFD UL subband configuration in one or more SBFD symbols or slots by higher layer signaling. For example, a frequency-domain location and a size or a frequency-domain occupancy of the SBFD UL subband may be provided to the UE by means of indicating or assigning a start RB and an allocation bandwidth, or based on an RIV value, or a number of RBs, or a bitmap. An SBFD UL subband configuration may be provided to the UE with respect to the CRB grid. An SBFD UL subband configuration may be provided to the UE with respect to a UE BWP configuration, e.g., excluding RBs in an NR carrier BW that are not within a configured or an active UE BWP. An SBFD UL subband configuration may be provided based on a reference RB and/or based on a reference SCS. The UE is provided with information for an SBFD guard band configuration in an SBFD symbol or slot by higher layer signaling. For example, a frequency-domain location and a size or a frequency-domain occupancy of an SBFD guard band may be provided to the UE by means of indicating or assigning a start RB and an allocation bandwidth, or an RIV value, or a number of RBs, or a bitmap, separately from a configuration provided to the UE for an SBFD UL subband. An SBFD guard band configuration may be provided to the UE with respect to a CRB grid, or with respect to a UE BWP configuration. An SBFD guard band configuration may be provided based on an indicated reference RB and/or based on a reference SCS. There may be multiple SBFD guard band configurations in an SBFD symbol or slot. If multiple SBFD guard band configurations are provided for an SBFD symbol or slot, the SBFD guard bands may be non-contiguous. For example, two SBFD guard band configurations may be provided to the UE for an SBFD symbol by higher layers. A same SBFD guard band configuration or a same SBFD UL subband configuration may be provided for multiple symbols or slots, or different symbols or slots may be indicated or assigned separate SBFD guard band and/or SBFD UL subband configurations, respectively.

The UE determines an SBFD DL subband using the provided SBFD UL subband and guard band configurations by assuming that RBs that are not part of the SBFD UL subband configuration and are not part of the SBFD guard band configuration provided by higher layer signaling over a reference bandwidth, are SBFD DL subband RBs. For example, the reference bandwidth may correspond to the NR DL or UL carrier bandwidth, or the reference bandwidth may correspond to a configured or an active DL BWP or UL BWP for the UE on a TDD cell. The UE may assume that no DL reception from the gNB or UL transmission to the gNB in an RB or SC corresponding to an SBFD guard band may occur.

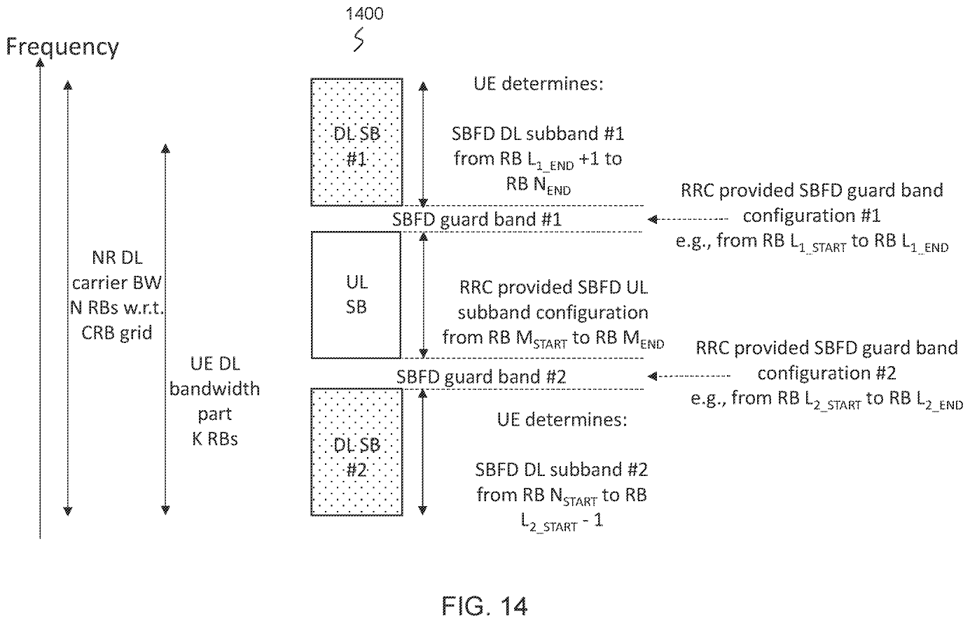

FIG. 14 illustrates an example for SBFD DL subband determination based on SBFD UL subband and SBFD guard band in a full-duplex communications system 1400 according to the embodiments of the disclosure. The embodiment of the SBFD DL subband determination in a full-duplex communication system 1400 illustrated in FIG. 14 is for illustration only. FIG. 14 does not limit the scope of this disclosure to any particular implementation of the SBFD DL subband determination in a full-duplex communications system 1400. In various embodiments, the SBFD DL subband determination may be implemented by the wireless network system 100.

An example SBFD configuration in a full-duplex communication system is shown in FIG. 14. Full-duplex operation is configured for NR band n78 using an SCS=30 kHz. Here, an NR DL carrier BW is N=273 RBs numbered from 0 to 272. A UE DL and UL BWP of size K=200 RBs which correspond to RBs 0-199 of the NR DL carrier BW is configured for a UE. The UE is indicated an SBFD UL subband configuration on RBs M_{START}=100 to M_{END}=150 on an SBFD symbol by higher layer signaling. The UE is indicated two SBFD guard bands by higher layer signaling. SBFD guard band #2 is located on RBs L_{2_START}=96 to L_{2_END}=99 and SBFD guard band #1 is located on RBs L_{1_START}=151 to L_{1_END}=154 with respect to the NR DL carrier BW, e.g., the CRB grid. Based on the NR DL carrier BW and the SBFD UL subband configuration and based on the SBFD guard band configuration, the UE determines the SBFD DL subbands to include the RBs from N_{START}=0 to L_{2_START}−1=95 and from RBs L_{1_END}+1=155 to N_{END}=272. The UE may assume that no DL receptions or UL transmissions using the SBFD guard bands occur. Using a configured or active UE DL BWP of size K=200 RBs, the UE determines if an SBFD DL subband is fully or partially or not at all included into the reception bandwidth. In the example, the UE determines that DL reception can occur in SBFD DL subband #2 can occur because the SBFD DL subband #2 is fully comprised in the active DL BWP of the UE. The UE determines that DL reception using the SBFD DL subband #1 may occur in RBs 155-199 of the SBFD DL subband #1 but may not occur in RBs 200-272 because the RBs 200-272 are not included in the active DL BWP of the UE.

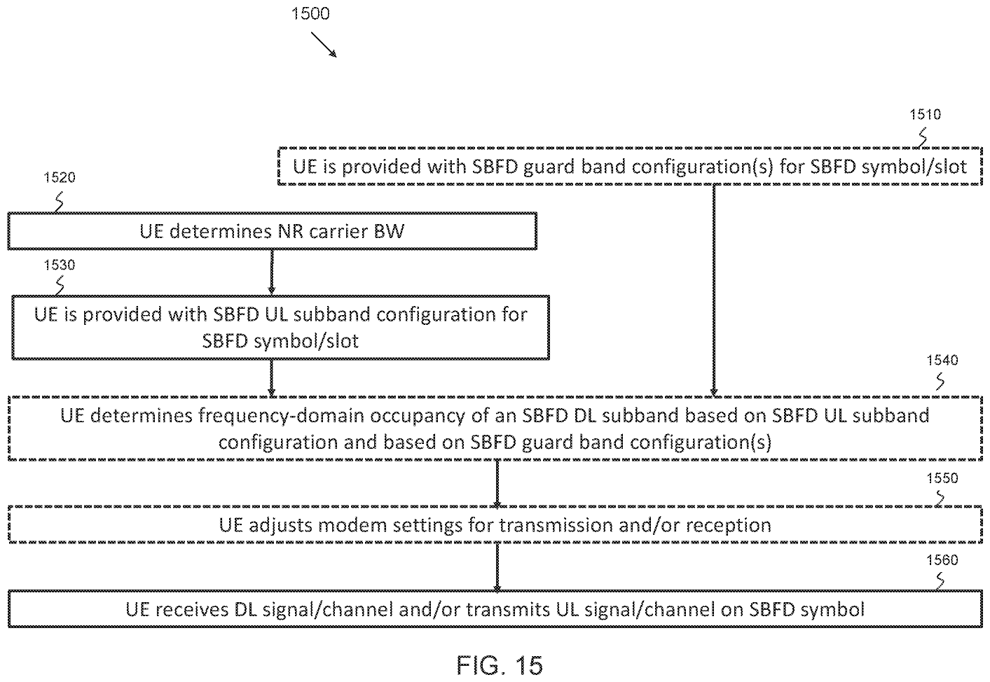

FIG. 15 shows an example UE processing flowchart 1500 for SBFD DL subband determination based on SBFD UL subband configuration and SBFD guard band configuration. The UE processing flowchart 1500 of FIG. 15 may be implemented by any UE, such as UE 111, 112, or 113, etc., of a wireless network system 100, in conjunction with a gNB 101, 102, or 103, etc.

The UE is provided with SBFD guard band configuration(s) for an SBFD symbol or slot, 1510. For example, one or two SBFD guard band configuration(s), e.g., for an SBFD configuration of type ‘DU’ or ‘UD’, or for an SBFD configuration of type ‘DUD’, respectively, may be provided to the UE. The UE determines an NR carrier BW, 1520. For example, the UE may determine an NR DL carrier BW based on SIB1. The UE is provided with an SBFD UL subband configuration for an SBFD symbol or slot, 1530. For example, the SBFD UL subband and SBFD guard band configuration(s), 1510 and 1530, may be signaled with reference to PRB numbering of the CRB grid or using equivalent reference RB numbering. The UE determines a frequency-domain occupancy, e.g., a set of RBs, for the SBFD DL subband(s) based on the SBFD UL subband configuration and based on the SBFD guard band configuration(s) with respect to the reference RB numbering, 1540. For example, the UE may determine a frequency occupancy, e.g., location and set of RBs, for one or two SBFD DL subband(s). The UE may determine that only a part of an SBFD DL subband, or of an SBFD UL subband or of an SBFD guard band are applicable with respect to a configured or an active UE BWP. For example, the UE may determine that parts or all of an SBFD DL subband is located partially or fully outside of a configured or an active DL BWP and some or all RBs of an SBFD DL subband are not applicable to its reception settings. Based on the frequency-domain occupancies of the SBFD subband(s) and/or guard band(s), the UE adjusts its modem settings for transmission and/or reception, 1550. For example, the UE may load into memory and/or apply Rx and/or Tx filter parameters for further receptions and/or transmissions on the SBFD subband(s). For example, a UE may configure a number of RBs or a set of RBs as not allowed for DL receptions and/or not allowed for UL transmissions even if scheduled or assigned or indicated by DCI or by higher layer signaling. The UE applies the adjusted modem settings and if scheduled or assigned or indicated DL receptions and/or UL transmissions, the UE receives and/or transmits using the adjusted modem settings, 1460.

In embodiments of this disclosure, one benefit is that signaling overhead for SBFD configuration(s) and subband assignment(s) is reduced. When the frequency-domain occupancies of an SBFD UL subband and SBFD guard band(s) are provided to the UE for an SBFD symbol/slot, the frequency-domain occupancy of an SBFD DL subband can be determined by the UE. The frequency-domain occupancies, e.g., sizes and/or locations, for SBFD UL subband and SBFD guard band(s) can be controlled separately by the gNB in the NR carrier BW. The UE is informed of the presence and the frequency-domain occupancy of an SBFD guard band. The UE can benefit from the use of advanced Tx-side or Rx-side filtering during transmissions and receptions using the SBFD subbands in the TDD cell supporting full-duplex operation which can increase radio range and link robustness.

In some embodiments, when the UE determines the frequency-domain occupancy of an SBFD DL subband based on an SBFD guard band configuration and based on an SBFD UL subband configuration, the SBFD guard band and SBFD UL subband configuration(s) may be provided for a same set or for separate sets of symbols/slots, respectively.

For example, an SBFD guard band configuration and an SBFD UL subband configuration may be provided for a same set of symbols/slots. The UE determines an SBFD DL subband configuration for the same set of symbols/slots provided by the SBFD guard band and UL subband configurations. When the same frequency-domain occupancies apply to an SBFD guard band and to an SBFD UL subband on a symbol from the set of symbols/slots, the UE then determines a same frequency-domain occupancy for the SBFD DL subband on the symbol.

For example, an SBFD guard band configuration and an SBFD UL subband configuration may be provided for different sets of symbols/slots where the different sets can partially overlap or not overlap. An SBFD guard band configuration is provided to the UE for a first set of symbols/slots. An SBFD UL subband configuration is provided to the UE for a second set of symbols/slots. The UE determines an SBFD DL subband for a third set of symbols/slots. The UE determines a frequency-domain occupancy of an SBFD DL subband for a symbol from the third set of symbols/slots based on an SBFD guard band configuration and based on an SBFD UL subband configuration when the symbol from the third set is comprised in both the first and the second sets of symbols/slots.

For example, an SBFD guard band configuration and an SBFD UL subband configuration may be provided for a same set or for different sets of symbols/slots where the different sets can partially overlap or not overlap. The UE determines an SBFD DL subband on a symbol using an SBFD guard band configuration and/or an SBFD UL subband configuration based on one or more reference symbol(s) or slot(s). An SBFD guard band configuration is provided to the UE for a first set of symbols/slots. An SBFD UL subband configuration is provided to the UE for a second set of symbols/slots. The UE determines an SBFD DL subband for a third set of symbols/slots. The UE determines a frequency-domain occupancy of an SBFD DL subband for a symbol from the third set of symbols/slots based on a first reference symbol or slot with reference to a symbol or slot from the first set of symbols/slots provided for an SBFD guard band configuration and/or based on a second reference symbol or slot with reference to a symbol or slot from the second set of symbols/slots provided for an SBFD UL subband configuration. The first reference symbol/slot and the second reference symbol/slot may be the same or different. A first reference symbol/slot and/or a second reference symbol/slot may be configured and/or indicated to the UE based on DCI signaling, MAC-CE signaling or RRC signaling, or correspond to a fixed value or be tabulated and provided by system operating specifications. Only one of the first or the second reference symbol/slot may be configured and/or indicated to the UE while the other reference symbol/slot may be a fixed or a tabulated value. Only one reference symbol/slot may be provided to the UE to determine the frequency-domain occupancy of an SBFD DL subband on a symbol from the third set of symbols/slots. For example, the UE may determine the SBFD DL subband on a symbol from the third set of symbols/slots based on an SBFD UL subband configuration on the same symbol in the second set of symbols/slots and using an SBFD guard band configuration on a reference symbol/slot from the first set of slots/symbols. The same principle may be applied when a reference symbol/slot is used from the second set of slots/symbols for the SBFD UL subband and the SBFD DL subband on a symbol is determined by the UE based on an SBFD guard band configuration for the same symbol.

For example, a relative symbol or slot offset value may be configured for a reference symbol/slot with respect to and SBFD guard band configuration or with respect to an SBFD UL subband configuration. The UE may determine a frequency-occupancy for an SBFD DL subband in a symbol or in a slot k based on an SBFD guard band and/or SBFD UL subband configuration provided for an earlier symbol or slot k−k_{ref} with k_{ref}>0, possibly under a side conditions that k_{ref} is larger or same than a minimum value such as k_{ref, min}=4 to provide a minimum application or processing delay to the UE.

An example SBFD configuration in a full-duplex communication system is considered for illustration purposes. Full-duplex operation is configured for NR band n78 using an SCS=30 kHz. Here, an NR DL carrier BW is N=273 RBs numbered from 0 to 272. A UE DL BWP of size K=200 RBs which corresponds to RBs 0-199 of the NR DL carrier BW is configured for a UE. The UE is indicated an SBFD UL subband allocation on RBs M_{START}=100 to M_{END}=150 on an SBFD symbol by higher layer signaling. The UE is indicated two SBFD guard bands by higher layer signaling. SBFD guard band #2 is located on RBs L_{2_START}=96 to L_{2_END}=99 and SBFD guard band #1 is located on RBs L_{1_START}=151 to L_{1_END}=154 with respect to the NR DL carrier BW, e.g., the CRB grid. The indicated SBFD guard band configuration and the SBFD UL subband configuration are the same on all symbols in a slot for the second and third slot of a DXXSU UL-DL frame configuration where ‘X’ denotes a slot supporting full-duplex operation in the TDD cell. Note that without loss of generality, it is assumed in this example that the first slot operates in DL-only mode, and the last slot operates in UL-only mode, and the fourth slot ‘S’ operates a DL part in DL-only mode and/or an UL part in UL-only mode. A reference symbol/slot with respect to the SBFD DL subband configuration is provided to the UE to determine an SBFD guard band on a slot/symbol. For example, the last symbol of the last full-duplex slot in a preceding UL-DL frame period n configured with an SBFD guard band is the reference symbol/slot for SBFD DL subband determination in a later UL-DL frame period. Based on the NR DL carrier BW and the SBFD UL subband configuration on a symbol, the UE determines the SBFD DL subbands on the same symbol in UL-DL frame period n+1 to include the RBs from N_{START}=0 to L_{2_START}−1=95 and from RBs L_{1_END}+1=155 to N_{END}=272 based on the reference symbol/slot. Using a configured or active UE DL BWP of size K=200 RBs, the UE determines the SBFD DL subband #2 to be fully comprised by the DL BWP and the SBFD DL subband #1 to be partially comprised by the DL BWP. A re-configuration of the SBFD guard band configuration is provided to the UE by higher layers in a PDSCH received in UL-DL frame period n or earlier. A modified SBFD guard band configuration increases the size of the SBFD guard band #1 to an indicated frequency-domain occupancy on RBs from L_{1_START}=151 to L_{1_END}=157. Accounting for sufficient activation delay of the new SBFD guard band configuration, the new SBFD guard band configuration #1 is applied starting from the first applicable slot in UL-DL frame period n+2. Based on the NR DL carrier BW and the SBFD UL subband configuration on a symbol, the UE determines the SBFD DL subband configurations in UL-DL frame period n+2 to include the RBs from N_{START}=0 to L_{2_START}−1=95 and from RBs L_{1_END}+1=155 to N_{END}=272 based on the reference symbol/slot from UL-DL frame period n+1 but then determines the SBFD guard bands in UL-DL frame period n+3 to include the RBs from N_{START}=0 to L_{2_START}−1=95 and from RBs L_{1_END}+1=158 to N_{END}=272 based on the reference symbol/slot from UL-DL frame period n+2.

In more embodiments, similar principles can be applied when: (a) a reference symbol/slot to determine an SBFD DL subband on a slot/symbol is provided, indicated, or defined with reference to a symbol/slot for an SBFD UL subband configuration, or (b) when a first reference symbol/slot is provided, indicated, or defined with respect to an SBFD guard band configuration and a second reference symbol/slot is provided, indicated or defined with respect to an SBFD UL subband configuration where the first and/or second reference symbol/slot may be a same or may be different.

A benefit of using a provided, an indicated, or a defined absolute or relative reference symbol/slot to determine an SBFD DL subband for another symbol or slot is that the UE modem design can account for sufficient application and processing delay, e.g., for loading or when changing filtering coefficients or when applying updated BB or RF modem configurations. Another benefit is that the determination of an SBFD DL subband on a symbol by the UE does not necessitate provision of both SBFD guard band and SBFD UL subband on the same symbol. An SBFD UL subband configuration may be provided for a different set of symbols/slots than an SBFD DL subband configuration which increases gNB-side flexibility for allocation of DL receptions and/or UL transmissions to a UE using full-duplex slots.

For example, when symbol level allocation granularity for a SBFD DL subband, or an SBFD UL subband, or an SBFD guard band configuration is supported, higher layer signaling may support large signaling payloads when a UE operates in RRC_CONNECTED mode using UE-dedicated RRC signaling. The SBFD UL and SBFD DL subband configuration(s) for UE determination of an SBFD guard band(s) configuration, or the SBFD guard band(s) and SBFD UL subband configuration for UE determination of an SBFD DL subband configuration, may be provided per-symbol or per symbol group. A reference symbol or reference symbol group configuration may be provided, indicated, configured, or assumed by the UE when determining the frequency-domain location(s) or the RB set(s) of SBFD guard band(s) or of SBFD DL subband(s) on a symbol or a symbol group. For example, the UE may determine the frequency-domain location(s) or the RB set(s) of an SBFD guard band or of an SBFD DL subband on symbol or symbol group #n in a slot, frame, or suitably selected reference period #k₁ based on the provided SBFD UL subband configuration and/or based on the provided SBFD DL subband configuration and/or based on the SBFD guard band configuration, respectively, for a symbol or symbol group #m in a reference period #k₂.

In another embodiment, the UE is provided with a frequency-domain limit value determining a start or and end of the frequency-domain occupancy of an SBFD DL subband, or of an SBFD UL subband, or of an SBFD guard band with respect to a reference RB. A frequency-domain limit value may be explicitly provided to a UE, i.e., configured or indicated or assigned or tabulated by system operating specifications for the UE. A frequency-domain limit value may be implicitly provided, i.e., determined by the UE, based on another parameter such as a frequency-domain occupancy of a UE BWP.

For example, a CRB grid may be selected for a reference RB numbering. A frequency-domain limit value determines a start RB of an SBFD DL or SBFD UL subband or an SBFD guard band configuration as a number of RBs as relative offset value with respect to a reference RB value such as CRB #0. A frequency-domain limit value determines an end RB of an SBFD DL or SBFD UL subband or an SBFD guard band configuration as a number of RBs as relative offset value with respect to a reference RB value such as the highest RB in the NR carrier BW.

For example, a configured or an active UE BWP may be selected for reference RB numbering. A frequency-domain limit value determines a start RB of an SBFD DL or an SBFD UL subband or an SBFD guard band configuration as a number of RBs as relative offset value with respect to a reference RB value such as a lowest RB of the UE BWP. A frequency-domain limit value determines an end RB of an SBFD DL or an SBFD UL subband or an SBFD guard band configuration as a number of RBs as a relative offset value with respect to a reference RB, such as a highest RB of a UE BWP.

For example, a relative start and/or a relative end offset value including a value 0, or greater, for the offset value of an SBFD DL subband, of an SBFD UL subband, or of an SBFD guard band configuration with respect to a reference RB such as CRB #0, or a lowest RB of a UE BWP, or a highest RB in the NR carrier BW, or a highest RB of a UE BWP may be provided, indicated, configured, defined, or signaled to a UE as a frequency-domain limit value. A frequency-domain limit value may be provided to the UE by higher layer signaling, or may be defined in system specifications, or made otherwise known to the UE.

For example, an SBFD configuration in a full-duplex communication system shown in FIG. 14 is considered. Full-duplex operation is configured for NR band n78 using an SCS=30 kHz. Here, an NR DL carrier BW is N=273 RBs numbered from 0 to 272. A UE DL and UL BWP of size K=200 RBs which correspond to RBs 0-199 of the NR DL carrier BW is configured for a UE. The UE is indicated an SBFD UL subband configuration on RBs M_{START}=100 to M_{END}=150 on an SBFD symbol by higher layer signaling. The UE is indicated two SBFD guard bands by higher layer signaling. SBFD guard band #2 is located on RBs L_{2_START}=96 to L_{2_END}=99 and SBFD guard band #1 is located on RBs L_{1_START}=151 to L_{1_END}=154 with respect to the NR DL carrier BW, e.g., the CRB grid.

For example, the UE is provided with a frequency-domain limit value X_{LOW}=15 RBs. Based on the SBFD UL subband configuration and based on the SBFD guard band configuration, the UE determines a possible SBFD DL subband to include the RBs from N_{START}=0 to L_{2_START}−1=95 and a possible SBFD DL subband to include RBs from L_{1_END}+1=155 to N_{END}=272 by excluding RBs indicated or configured as SBFD UL subband and SBFD guard band from the NR carrier BW. Based on the frequency-domain limit value X_{LOW}, the UE determines that an actual SBFD DL subband #2 starts from RB N_{START}=15, e.g., N_{START}=X_{LOW} and ends in RB L_{2_START}−1=95. In the example, the UE determines that DL reception can occur in SBFD DL subband #2 because the SBFD DL subband #2 is fully comprised in the active DL BWP of the UE. The UE determines that DL reception using the SBFD DL subband #1 may occur in RBs 155-199 of the SBFD DL subband #1, because RBs 200-272 are not included in the active DL BWP of the UE.

For example, the UE is provided with a frequency-domain limit value X_{HIGH}=190 RBs. Based on the frequency-domain limit value X_{HIGH}, the UE determines that an actual SBFD DL subband #1 ends in RB N_{START}=190, e.g., the N_{END}=X_{HIGH}, and begins in RB L_{1_END}+1=155. In the example, the UE determines that DL reception can occur in SBFD DL subband #1 because the SBFD DL subband #1 is fully within the active DL BWP of the UE. The UE determines that DL reception using the SBFD DL subband #1 may occur in RBs 155-189 of the SBFD DL subband #1, because RBs 200-272 are not included in the active DL BWP of the UE and X_{HIGH} indicated an actual last RB of the SBFD DL subband #1 lower than the highest RB of the UE DL BWP.

Similar principles as illustrated can be applied when a frequency-domain limit value determining a start or an end of the frequency-domain occupancy of an SBFD DL subband, or of an SBFD UL subband or of an SBFD guard band is provided as relative offset value with respect to a lowest or highest RB, respectively, of a UE BWP.

A motivation for providing a lower and/or a higher frequency-domain limit value X_{LOW} and/or X_{HIGH} to the UE is that an SBFD subband determination by the UE can avoid the need for the gNB to assign all RBs down to the lowest or up to the highest RB of the NR carrier BW or the UL/DL BWP pair for the implicitly determined SBFD subband type. For example, when an ‘DUD’ type SBFD configuration is needed on a TDD cell supporting full-duplex operation, a number of RBs at the NR carrier edge can be used as guard RBs independent from the SBFD guard bands #1 and/or #2 separating the SBFD DL and UL subbands, respectively. One benefit is increased adjacent channel protection when intra-band contiguous carrier aggregation is deployed. For example, when a ‘DU’ or ‘UD’ type SBFD configuration is needed on a TDD cell supporting full-duplex operation, a number of separate guard RBs can be configured at the edges of the UE BWP, e.g., not all RBs comprised by the UE BWP need to be determined as either SBFD UL subband, or SBFD DL subband or SBFD guard band separating the SBFD DL and UL subbands. One benefit is increased UE-to-UE CLI protection.

In one embodiment, the UE is provided with a frequency-domain adjustment value determining a minimum or a maximum or a default size for a frequency-domain occupancy of an SBFD DL subband or of an SBFD UL subband or of an SBFD guard band.

For example, a minimum or a maximum or a default size of an SBFD DL subband, an SBFD UL subband, or an SBFD guard band configuration may be provided, indicated, configured, defined, or signaled as frequency-domain adjustment value. A frequency-domain adjustment value may be provided as information to the UE by higher layer signaling, or be defined in system specifications, or may be indicated or assigned to the UE based on DCI or MAC-CE signaling.

For example, an SBFD configuration in a full-duplex communication system shown in FIG. 12 is considered. For example, when the UE determines the frequency-domain occupancy of an SBFD guard band based on the frequency-domain locations of an SBFD UL subband and an SBFD DL subband, the frequency-domain adjustment value may represent a minimum or a maximum or a default number of RBs (or SCs) that the UE determines for the number of RBs (or SCs) of an SBFD guard band. For example, a configurable frequency-domain adjustment value of Z=3 RBs provided to the UE may be associated with a minimum SBFD guard band size. For example, when the UE is provided with an SBFD UL subband configuration on RBs 100-150 on an SBFD symbol and with two SBFD DL subband configurations on RBs 10-98 for SBFD DL subband #2 and on RBs 155-272 for SBFD DL subband #1, respectively, the UE determines that the resulting SBFD guard band #2 on RB 99 is smaller than a frequency-domain adjustment value Z=3 RBs, and the UE applies the minimum SBFD guard band size of Z=3 RBs and assumes that RBs 97-99 as the actual SBFD guard band #2. The UE determines that the resulting SBFD guard band #1 on RBs 151-154 is larger than a frequency-domain adjustment value Z=3 RBs, and the UE applies the determined SBFD guard band size as actual SBFD guard band and assumes RBs 151-154 for the actual SBFD guard band #1. A similar approach can be applied to the case where an SBFD guard band configuration is provided to the UE for determination by the UE of an SBFD DL subband based on an SBFD UL subband.

In various embodiments, similar principles as illustrated by the examples can be applied when a frequency-domain adjustment value determining a minimum or a maximum or a default size of an SBFD DL subband or an SBFD UL subband frequency-domain occupancy is provided with respect to a size of a UE BWP.

In one embodiment, the UE is provided with information for a reference BWP to determine a frequency-domain occupancy of an SBFD DL subband, or of an SBFD UL subband, or of an SBFD guard band in a reception or transmission bandwidth. A reference BWP may be provided to a UE, i.e., a reference BWP of a UE is configured or indicated or assigned to the UE or is tabulated by system operating specifications for the UE. A reference BWP may be determined by the UE, i.e., a UE determines an active UE BWP of a serving cell to be a reference BWP. A reference BWP of a UE may be selected by the UE from a DL BWP and a UL BWP on a symbol based on a condition such as a transmission direction. A reference BWP may correspond to an actual BWP, i.e., one from a set of configured DL BWP(s) for UE receptions in a DL bandwidth or one from a set of configured UL BWP(s) for UE transmissions in an UL bandwidth, or a reference BWP may correspond to an assumed, or a virtual BWP configuration for which parameters are provided to or determined by the UE. A reference BWP for UE determination of a frequency-occupancy of an SBFD DL subband, of an SBFD UL subband or an SBFD guard band on a serving cell may be provided to the UE or determined by the UE for a secondary cell or a secondary cell group, e.g., when a TDD serving cell supporting SBFD operation is configured as SCell.

A motivation for the use of a reference BWP is enabling SBFD configuration and flexible DL/UL scheduling using SBFD subbands by the gNB in a TDD cell supporting SBFD operation which can increase cell aggregate and UE peak throughput and spectral efficiency. A benefit of providing a reference BWP is that UL-only scheduling or UL transmissions using SBFD mode on a flexible symbol can be adjusted by the gNB to control and set separate UL transmission bandwidth(s) settings for a flexible symbol and an uplink symbol, respectively, for the UE. It can be avoided that the (single) active UL BWP determines the allowed UL transmission bandwidth for any UL transmission by the UE in both a flexible symbol and an uplink only. A benefit is that SBFD operation on a symbol type ‘D’ may be configured separately when compared to SBFD operation on a symbol type ‘F’. SBFD operation on a symbol type ‘F’ may then be separately configured for the UE with respect to a reference DL BWP or a reference UL BWP of the UE such that SBFD DL subband, SBFD UL subband, and/or SBFD guard bands are configured, indicated or assigned on the symbol type according to the possibly different needs of the gNB SIC implementation when supporting switching to DL-only, or UL-only or SBFD modes of transmission and/or reception on a symbol of type ‘F’. For example, a separate size for an SBFD guard band configuration can be indicated to or determined by the UE on the symbol type ‘F’ where a legacy UE may also be scheduled UL transmissions in an SBFD UL subband when compared to symbol of type ‘D’ where a legacy UE may be scheduled for DL transmissions only. A benefit when using a reference BWP is reduced UE modem implementation complexity. It may be expected that the frequency-domain occupancy of an SBFD DL subband, SBFD UL subband, or SBFD guard band configuration on a symbol is often a property of the NR carrier BW and the available operator band segment in the TDD deployment. For example, a frequency-domain location and size of an SBFD UL subband in the NR carrier BW is then selected by the operator as a function of the coexistence needs for the NR deployment and as function of the gNB-side full-duplex implementation. A DL BWP and a UL BWP for a UE determine the UE reception and the UE transmission bandwidth in the NR DL carrier bandwidth and the NR UL carrier bandwidth, respectively. When designating a reference BWP, a benefit for a UE implementation supporting multiple BWPs, e.g., Rel-15 NR feature groups (FGs) FG 6-2 or 6-4 is that it can be avoided that an indicated or a determined SBFD subband configuration on a symbol needs to be computed and stored multiple times, e.g., per BWP, and must be loaded into memory when the active BWP of the UE is switched. An SBFD DL subband, SBFD DL subband, or an SBFD guard band on a symbol can be indicated to or determined by the UE separately from the active UE DL and UL BWPs determining a DL reception and UL transmission bandwidth on a symbol, respectively.

For example, a CRB grid may be used for a reference RB numbering with respect to which the UE determines a frequency-domain occupancy of an SBFD DL subband, of an SBFD UL subband, or of an SBFD guard band based on a reference BWP.

For example, a reference BWP may correspond to an actual or a configured UE BWP. A UE may be configured with a number of DL BWPs on a serving cell, e.g., up to 4, with a single DL BWP active at a given time. The UE is not expected to receive PDSCH, PDCCH, or CSI-RS (except for RRM) outside an active BWP. The UE may be configured with a number of UL BWPs on a serving cell, e.g., up to 4, with a single UL BWP active at a given time. The UE does not transmit PUSCH or PUCCH outside an active BWP. For operation using unpaired spectrum, the UE may not be expected to receive a configuration where the center frequency for a DL BWP is different than the center frequency for an UL BWP where the BWP-Id of the DL BWP is same as the BWP-Id of the UL BWP. A first bandwidth of a UE DL BWP may be the same or may be different from a second bandwidth of a UE UL BWP even if a same BWP-Id is configured for the BWP pair. A first bandwidth of a UE DL BWP (or UL BWP) may be the same or may be different from a second bandwidth of another UE DL BWP (or UL BWP) configured for the UE in a TDD serving cell. When a UE supports multiple configured DL BWPs, e.g., 2 or 4, one from the set of configured DL BWPs may be determined by or be indicated to the UE as a reference DL BWP. When a UE supports multiple configured UL BWPs, e.g., 2 or 4, one from the set of configured UL BWPs may be determined by or be indicated to the UE as a reference UL BWP.

For example, when multiple DL BWPs are configured for the UE, one of the configured DL BWPs may be indicated to or determined by the UE as the reference DL BWP for the UE to determine a frequency-domain occupancy of an SBFD DL subband, of an SBFD UL subband, or of an SBFD guard band on a symbol. The UE uses the provided or determined parameters of the reference DL BWP associated with the reference BWP to determine a frequency-domain occupancy of an SBFD DL subband, or of an SBFD UL subband, or of an SBFD guard band on a symbol, e.g., based on the NR DL carrier BW. When the reference DL BWP is the active DL BWP, a DL reception BW of the UE is determined by the DL BWP on the serving cell, e.g., RBs of an SBFD DL subband outside the active DL BWP may not be available for DL receptions by the UE. When the reference DL BWP is not an active DL BWP, the UE determines the frequency-domain occupancy of an SBFD DL subband, of an SBFD UL subband, or of an SBFD guard band based on the reference DL BWP, and the UE determines a DL reception BW based on the active DL BWP on the serving cell, e.g., RBs of an SBFD DL subband determined based on the reference DL BWP but outside the active DL BWP may not be available for DL receptions by the UE.

For example, when multiple UL BWPs are configured for the UE, one of the configured UL BWPs may be indicated to or determined by the UE as the reference UL BWP for the UE to determine a frequency-domain occupancy of an SBFD DL subband, of an SBFD UL subband, or of an SBFD guard band on a symbol. The UE uses the provided or determined parameters of the reference UL BWP associated with the reference BWP to determine a frequency-domain occupancy of an SBFD DL subband, or of an SBFD UL subband, or of an SBFD guard band on a symbol, e.g., based on the NR UL carrier BW. When the reference UL BWP is the active UL BWP, an UL transmission BW of the UE is determined by the UL BWP on the serving cell, e.g., RBs of an SBFD UL subband outside the active UL BWP may not be available for UL transmissions by the UE. When the reference UL BWP is not an active UL BWP, the UE determines the frequency-domain occupancy of an SBFD DL subband, or of an SBFD UL subband, or of an SBFD guard band based on the reference UL BWP, and the UE determines an UL transmission BW based on the active UL BWP on the serving cell, e.g., RBs of an SBFD UL subband determined based on the reference UL BWP but outside the active UL BWP may not be available for UL transmissions from the UE.

For example, a reference BWP for the UE determination of a frequency-domain occupancy of an SBFD DL subband, or of an SBFD UL subband, or of an SBFD guard band on a symbol may be indicated as a default DL BWP or as a default UL BWP, e.g., the DL BWP or the UL BWP to be used by a UE upon expiry of the BWP inactivity timer.

For example, a reference BWP configuration for the DL or the UL directions may correspond to an assumed or virtual BWP. A UE may be provided or may determine parameters such as an SCS, a CP, a frequency-domain occupancy, e.g., a start RB and number of contiguous RBs, and/or a virtual BWP ID for an assumed or virtual BWP. The UE uses the provided or determined parameters of an assumed or a virtual BWP associated with the reference BWP to determine a frequency-domain occupancy of an SBFD DL subband, or of an SBFD UL subband, or of an SBFD guard band on a symbol separately from a DL reception BW or an UL transmission BW of the UE based on the active UE DL BWP or the active UE UL BWP on that symbol, e.g., where an active UE BWP is from the set of configured BWPs.

For example, separate reference BWPs, e.g., using separate parameters BWP-Id, may be provided to the UE as a first DL reference BWP and as a second UL reference BWP, respectively, or a same BWP pair, e.g., using a same parameter BWP-Id, may be provided to the UE as a reference BWP or a reference BWP pair for the DL and the UL.

A UE (e.g., 111, 112, 113, etc.) may be provided with information to determine a first frequency-domain occupancy, or configuration for an SBFD DL subband, an SBFD DL subband, and/or an SBFD guard band on a symbol based on a first reference BWP and the UE may be provided with information to determine a second frequency-domain occupancy, or configuration for an SBFD DL subband, an SBFD DL subband and/or an SBFD guard band on the symbol based on a second reference BWP based on a condition such as a transmission direction of a symbol.

For example, a UE may determine a first frequency-domain occupancy or configuration for an SBFD DL subband, an SBFD DL subband and/or an SBFD guard band on a symbol based on a reference DL BWP for the case that the transmission direction of symbol of type ‘F’ is indicated or assigned for DL-only receptions by UEs, or for the case that SBFD type of DL receptions and UL transmissions by/from UEs are indicated or determined for the symbol. The UE determines a second frequency-domain occupancy, or configuration for an SBFD DL subband, an SBFD UL subband and/or an SBFD guard band on the symbol based on a reference UL BWP for the case that the transmission direction of the symbol of type ‘F’ is indicated or assigned for UL-only transmissions from UEs.

For example, a reference BWP for UE determination of a frequency-domain occupancy of an SBFD DL subband, or of an SBFD UL subband, or of an SBFD guard band on a downlink symbol, i.e., a symbol of type ‘D’ may be a UE DL BWP. A reference BWP for determination of a frequency-domain occupancy of an SBFD DL subband, or of an SBFD UL subband, or of an SBFD guard band on a flexible symbol, i.e., a symbol of type ‘F’, may be a UE DL BWP when the symbol is determined by the UE or indicated to the UE for DL-only receptions and/or SBFD operation, or the reference BWP may be a UE UL BWP when the symbol is determined by the UE or indicated to the UE for UL-only transmissions. A reference BWP for determination of a frequency-domain occupancy of an SBFD DL subband, or of an SBFD UL subband, or of an SBFD guard band on an uplink symbol, i.e., a symbol of type ‘U’, may be a UE UL BWP such as when SBFD operation with an SBFD DL subband is supported on symbol type ‘U’.

In further examples, a reference BWP for UE determination of a frequency-domain occupancy of an SBFD DL subband, or of an SBFD UL subband, or of an SBFD guard band on a flexible symbol, i.e., a symbol of type ‘F’, may be a virtual UL BWP when the symbol is determined by the UE or indicated to the UE for UL-only transmissions and/or SBFD operation where an UL transmissions may be scheduled or assigned at least inside an SBFD UL subband on the symbol. The UE determines an allowed or a possible UL transmission BW on a flexible symbol when the flexible symbol is determined by the UE or indicated to the UE as uplink symbol or for an UL transmission in the SBFD UL subband based on the virtual reference BWP. The UE determines an allowed or a possible UL transmissions bandwidth for an uplink symbol based on the active UE UL BWP.

In another example, a reference BWP for UE determination of a frequency-domain occupancy of an SBFD DL subband, or of an SBFD UL subband, or of an SBFD guard band may be provided to the UE or determined by the UE for a secondary cell, i.e., an SCell configured for the UE in carrier aggregation or dual-connectivity. The UE determines a frequency-domain occupancy of an SBFD DL subband, or of an SBFD UL subband, or of an SBFD guard band based on the reference BWP provided or determined for the SCell.

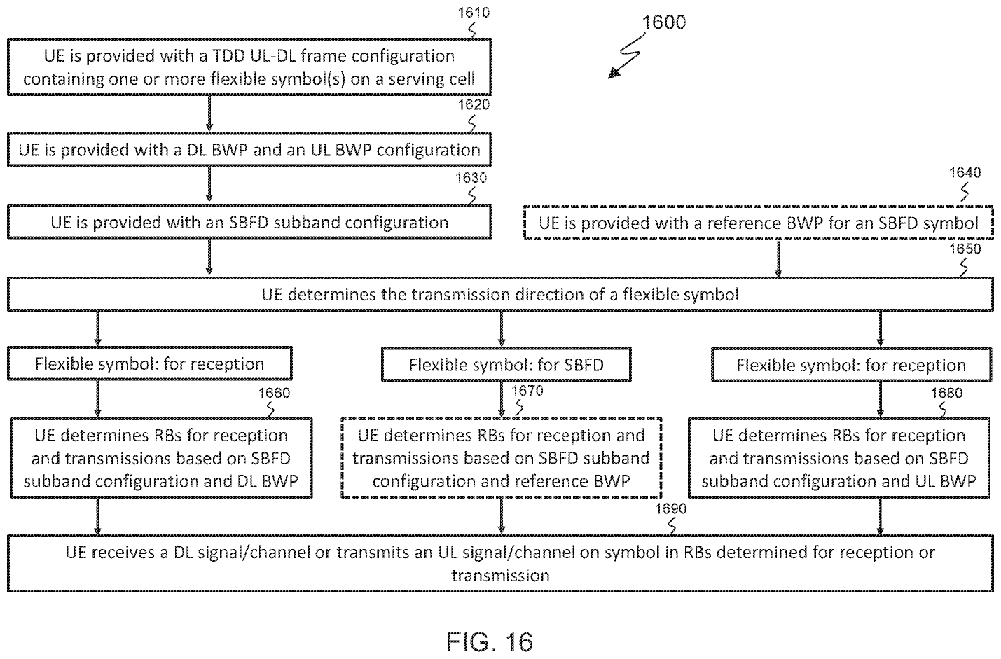

FIG. 16 shows an example UE processing flowchart 1600 for determination of an SBFD subband configuration based on a reference BWP. UE processing flowchart 1600 may be implemented by any UE (e.g., 111, 112, or 113, etc.) part of a wireless network 100 in conjunction with a gNB (e.g., 101, 102, or 103, etc.).

The UE is provided with a TDD UL-DL frame configuration containing one or more flexible symbols in respective slots, 1610. For example, a TDD UL-DL frame configuration may be indicated to the UE in SIB1 or in an IE ServingCellConfigCommon when the UE is in RRC_CONNECTED mode. The UE is provided with a DL BWP and an UL BWP configuration, 1620. For example, the UE may be configured with one or multiple DL BWPs, and with one or multiple UL BWPs. The UE is provided with an SBFD subband configuration, 1630. For example, the UE may be configured with an SBFD DL subband, an SBFD UL subband, or an SBFD guard band on one or more symbols where symbols may be of different types such as ‘D’ or ‘F’. For example, the UE may be configured with an SBFD configuration of type ‘DUD’, i.e., two SBFD DL subbands and one SBFD UL subband for ‘D’ and ‘F’ symbol types. For example, a same of different SBFD configurations for a symbol type ‘D’ and a symbol type ‘F’ may be provided to the UE. The UE is provided with a reference BWP for an SBFD symbol, 1640. For example, a reference BWP may indicate a frequency-domain occupancy or a start RB and contiguous number of RBs. For example, a reference BWP may be a configured DL BWP or a configured UL BWP or may be a virtual reference BWP. The UE determines the transmission direction of a flexible symbol, 1650. For example, the transmission direction of a flexible symbol may be indicated to the UE by DCI of a DL assignment or an UL grant or based on reception of a group-common DCI such as an SFI. The UE determines the set(s) of RBs for transmission and/or reception based on the SBFD subband configuration, e.g., for transmissions in an SBFD UL subband or for receptions in an SBFD DL subband and based on a BWP. For example, when the flexible symbol is indicated for DL reception, the UE determines the set(s) of RBs based on the DL BWP 1660, when the flexible symbol is indicated for transmission and reception, e.g., SBFD operation, the UE determines the set(s) of RBs based on the reference BWP 1670, and when the flexible symbol is indicated for UL transmission, the UE determines the set(s) of RBs based on the UL BWP, 1680. The UE then receives a DL signal or channel or transmits an UL signal or channel on symbols in RBs determined for reception or transmission, 1690.

In another embodiment, first and second SBFD UL subband configurations are provided to the UE by higher layer signaling. The first and second SBFD UL subband configurations may indicate different sets of time-domain resources for SBFD operation to a UE. The first and second SBFD UL subband configurations may indicate different frequency-domain resources configured for SBFD operation to a UE on a symbol or slot.

In other embodiments, the UE is provided a first SBFD UL subband configuration for a number of SBFD symbols or slots by higher layer signaling. The frequency location of the SBFD UL subband may be provided by means of providing a start RB and an allocation bandwidth, an RIV/SLIV value, a number of RBs, or a bitmap. The SBFD UL subband configuration may be indicated to the UE with respect to the CRB grid. Alternatively, the SBFD UL subband allocation may be indicated to the UE with respect to a configurable BWP. Alternatively, the SBFD UL subband allocation may be indicated using a configurable reference RB and may be expressed with respect to a reference SCS. The time-domain locations of the first SBFD UL subband may be provided by means of providing a list of symbols or slots, using a start, or an end or a run length of slots, or a bitmap associating a bit with one or multiple symbols or slots. The UE is provided with time-domain locations of a second SBFD UL subband by means of a list of symbols or slots, using a start, or an end or a run length of slots or a bitmap associating a bit with one or multiple symbols or slots. For example, the indicated time-domain locations of the second SBFD UL subband may be same or may include only a subset of entries provided by the first SBFD UL subband configuration. For example, the frequency locations of the first and second SBFS UL subband configuration on an SBFD symbol or in an SBFD slot may be same, and not be separately indicated by higher layers, or they may be different for some or all time-domain resources. The UE determines UL transmissions as schedulable or configurable in the SBFD symbols/slots indicated by the first SBFD UL subband configuration. The UE determines DL transmissions using the configured or indicated SBFD UL subband as schedulable or configurable in the SBFD symbols/slots of the second SBFD UL subband configuration.

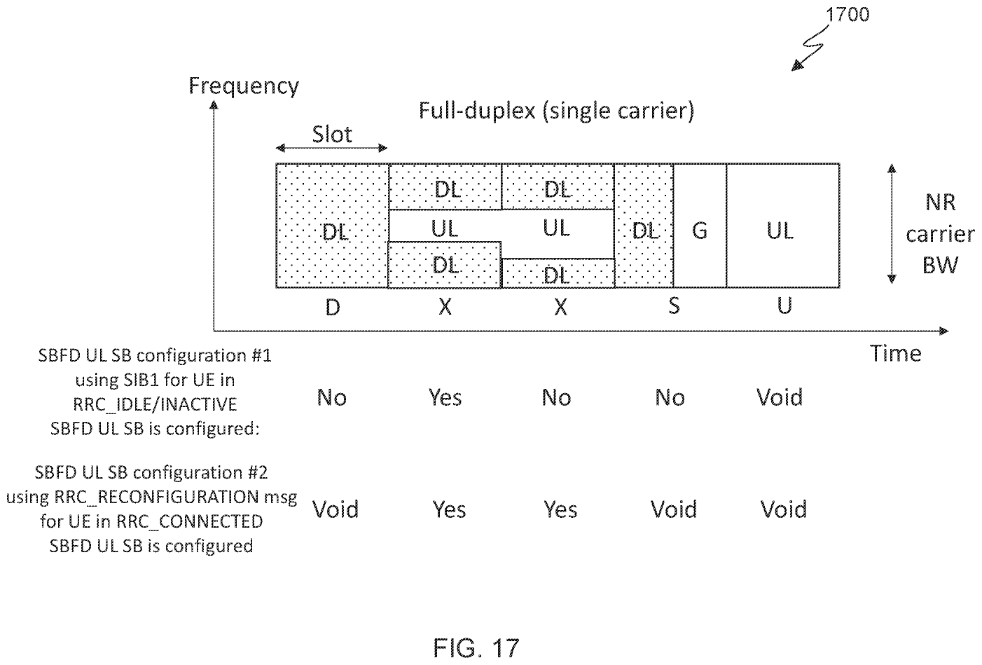

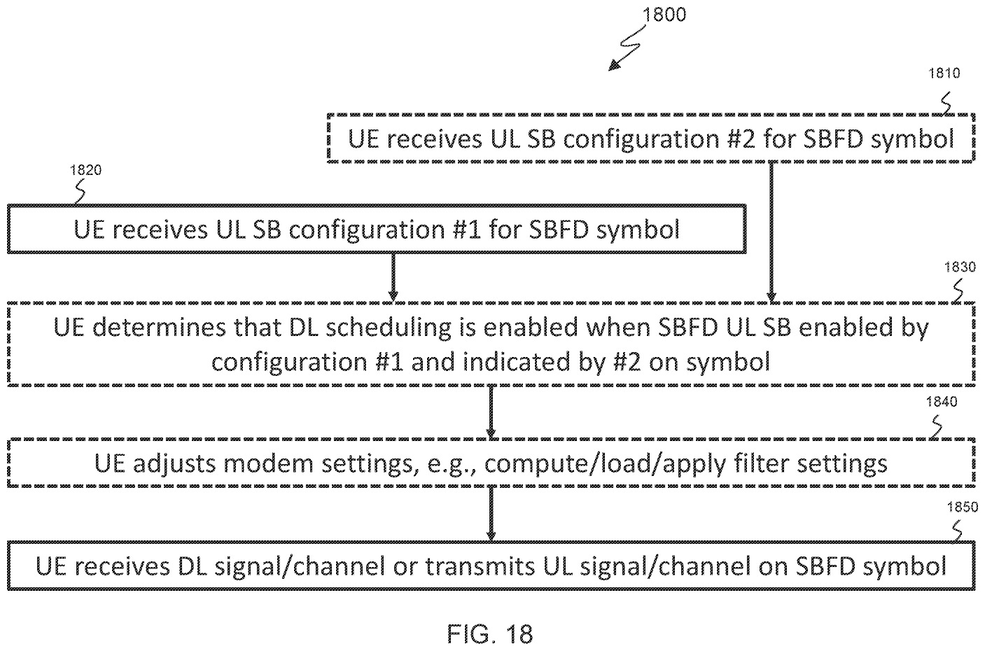

With reference to FIGS. 17 and 18, an indication of DL schedulable symbols/slots of RRC associated with an UL subband configuration may be determined. FIG. 17 illustrates one of several possible configurations 1700 that can be implemented by a UE (e.g., 111, 112, 113, etc.) and FIG. 18 illustrate a UE processing flowchart of a method 1800 to determine DL schedulable symbols/slots associated with an UL subband configuration.

The method 1800 beings with the UE receiving UL SB configuration #2 for a SBFD symbol, 1810. The UE then receives UL SB configuration #1 for a SBFD symbol, 1820. The UE then determines that DL scheduling is enabled when SBFD UL SB enabled by configuration #1 and indicated by #2 on symbol, 1830. The UE then adjusts modem settings, for example, by computing, loading, and or applying filter settings, 1840. The UE then receives a DL signal or channel or transmits an UL signal or channel on the SBFD symbol, 1850.

In one example, using band n78 and SCS=30 kHz for illustration purposes, the NR carrier BW for UL transmissions and DL receptions is 273 RBs numbered from 0 to 272. The DL BWP and the UL BWP for the UE is 200 RBs and correspond to RBs 0-199 of the NR carrier BW. The UE is provided first and second SBFD UL subband allocations on RBs 100-150 on an SBFD symbol by higher layer signaling. The first SBFD UL subband allocation indicates all symbols in SBFD slots #2 and #3. The second SBFD UL subband allocation indicates all symbols in SBFD slot #3. The UE determines that only UL transmissions may be scheduled or configured by the gNB in SBFD slot #2 on the indicated RBs 100-150 of the UL subband. The UE determines that either DL or UL transmissions may be scheduled or configured by the gNB in SBFD slot #3 on the indicated RBs 100-150 of the UL subband.

In another example, using band n78 and SCS=30 kHz for illustration purposes, the NR carrier BW for UL transmission and DL receptions is 273 RBs numbered from 0 to 272. The DL BWP and the UL BWP for the UE is 200 RBs and correspond to RBs 0-199 of the NR carrier BW. The UE is provided first and second SBFD UL subband allocations on RBs 100-150 on an SBFD symbol by higher layer signaling. The first SBFD UL subband allocation indicates symbols #2-13 in SBFD slots #2 and #3 and the second SBFD UL subband allocation indicates symbols #0-1 in SBFD slots #2 and #3 where symbol numbering in a slot starts with #0. The UE determines that only UL transmissions may be scheduled or configured by the gNB in symbols #2-13 of SBFD slots #2 and #3 on the indicated RBs 100-150 of the UL subband. The UE determines that either DL or UL transmissions may be scheduled or configured by the gNB in symbols #0-1 in SBFD slots #2 and #3 on the indicated RBs 100-150 of the UL subband. For example, the symbols #0 and #1 may then be used for PDCCH transmission by the gNB during SBFD operation.

In other embodiments, the UE is provided a first SBFD UL subband configuration for a number of SBFD symbols or slots by higher layer signaling. The frequency location of the SBFD UL subband may be provided by means of providing a start RB and an allocation bandwidth, an RIV/SLIV value, a number of RBs, or a bitmap. The SBFD UL subband configuration may be indicated to the UE with respect to the CRB grid. Alternatively, the SBFD UL subband allocation may be indicated to the UE with respect to a configurable BWP. Alternatively, the SBFD UL subband allocation may be indicated to the UE using a configurable reference RB and may be expressed with respect to a reference SCS. The time-domain locations of the first SBFD UL subband may be indicated by means of providing a list of symbols or slots, using a start, or an end or a run length of slots, or a bitmap associating a bit with one or multiple symbols or slots. The UE is provided with frequency location or time-domain locations of a second SBFD UL subband configuration in analogous manner. For example, the indicated frequency-domain and time-domain locations of the second SBFD UL subband may be same or may include only a subset of corresponding entries provided by the first SBFD UL subband configuration. For example, the frequency locations of the first and second SBFS UL subband configuration on an SBFD symbol or in an SBFD slot may be same and not separately indicated by higher layers, or may be different for some or all time-domain resources. The UE determines UL transmissions as schedulable or configurable in the SBFD UL subband allocation on a symbol indicated by the first SBFD UL subband configuration. The UE determines DL receptions using the configured or indicated SBFD UL subband as schedulable or configurable on the SBFD symbols/slots using the second SBFD UL subband configuration.

In one example, using band n78 and SCS=30 kHz for illustration purposes, the NR carrier BW for UL transmissions and DL receptions is 273 RBs numbered from 0 to 272. The DL BWP and the UL BWP for the UE is 200 RBs and correspond to RBs 0-199 of the NR carrier BW. The UE is provided first and second SBFD UL subband allocations indicating RBs 100-150 and RBs 130-150, respectively, on a same SBFD symbol by higher layer signaling. For simplicity and illustration purposes, it is assumed that both SBFD UL subband allocation indicate a same set of symbols, such as all symbols in SBFD slots #2 and #3. The UE determines that only UL transmissions may be scheduled or configured by the gNB in SBFD slots #2 and #3 on the indicated RBs 100-129 of the first SBFD UL subband configuration. RBs #130-150 are also indicated as part of the second SBFD UL subband configuration. The UE determines that either DL receptions or UL transmissions may be scheduled or configured by the gNB in SBFD slots #2 and #3 on the indicated RBs 130-150 indicated as permitted or allowed for DL scheduling.

In another example, using band n78 and SCS=30 kHz for illustration purposes, the NR carrier BW for UL transmissions and DL receptions is 273 RBs numbered from 0 to 272. The DL BWP and the UL BWP is 200 RBs and correspond to RBs 0-199 of the NR carrier BW. The UE is provided a first SBFD UL subband allocation indicating RBs 100-150 by higher layer signaling. For simplicity and illustration purposes, it is assumed that the first SBFD UL subband allocation indicates all symbols in SBFD slots #2 and #3. A second SBFD configuration is provided to the UE associated with transmission type ‘DUD’ for symbols in SBFD slot #2 and transmission types {‘DUD’, ‘DDD’} for symbols in slot #3. The UE determines that only UL transmissions may be scheduled or configured by the gNB in SBFD slot #2 on the indicated RBs 100-150 of the first SBFD UL subband configuration. The UE determines that either DL or UL transmissions may be scheduled or configured by the gNB in SBFD slot #3 on the indicated RBs 100-150 indicated by the first SBFD UL subband configuration.

Another distinct advantage of the embodiments disclosed herein is that DL and UL scheduling behavior for parts of the SBFD UL subband is configurable by the gNB during SBFD operation. The flexibility of DL and UL scheduling using the SBFD UL subband on SBFD symbols or slots can be restricted to a desired subset of time-domain resources or frequency-domain resources in the SBFD UL subband configuration. This makes it possible to reduce UE modem complexity when implementing Tx or Rx side filtering on the SBFD UL or UL subbands.

When symbol level granularity configuration of SBFD configuration is desired using higher layer signaling, such as when the UE is in RRC_CONNECTED mode, the SBFD UL subband configurations for UE determination of the allowed or dis-allowed transmissions behavior may be provided per symbol or symbol group. A first reference symbol configuration may be assumed by the UE when determining locations or sizes of UL subbands on a second symbol. For example, the UE may determine frequency location and size of the transmission behavior on symbol #n in a slot, frame, or reference period using the SBFD UL subband configuration provided for symbol #m.

In another embodiment, first and second SBFD subbands configurations associated with different RRC states is provided to the UE by higher layer signaling. The first SBFD subbands configuration may be associated with SBFD operation for a UE in RRC_IDLE/INACTIVE mode, and the second SBFD subbands configuration may be associated with SBFD operation for a UE in RRC_CONNECTED mode. The first and second SBFD subbands configurations may indicate different sets of time-domain resources configured for SBFD operation to a UE. The first and the second SBFD subbands configurations may indicate different frequency-domain resources configured for SBFD operation to a UE on a symbol or slot. One of the first and second SBFD subbands configurations may indicate only some SBFD subband types, such as SBFD UL subband, SBFD DL subband, or SBFD guard band, to the UE. The first SBFD subband configuration may indicate SBFD time-domain or frequency-domain locations of an SBFD subband with reduced allocation granularity in time-domain or in frequency-domain with reference to the second SBFD subband configuration.

In some embodiments, a UE in RRC_IDLE/INACTIVE mode is provided a first SBFD subband configuration that indicates only an SBFD UL subband for a number of SBFD symbols or slots by higher layer signaling, such as SIB1. The frequency location of the SBFD UL subband may be provided by means of providing a start RB and an allocation bandwidth, an RIV/SLIV value, a number of RBs, or a bitmap. The SBFD UL subband configuration may be indicated to the UE with respect to the CRB grid. Alternatively, the SBFD UL subband allocation may be indicated to the UE with respect to a configurable BWP such as the initial UL BWP. Alternatively, the SBFD UL subband allocation may be indicated using a configurable reference RB and may be expressed with respect to a reference SCS. The time-domain locations of the first SBFD UL subband may be provided by means of providing a list of symbols or slots, using a start, or an end or a run length of slots or a bitmap associating a bit with one or multiple symbols or slots. The UE in RRC_CONNECTED mode is provided with a second SBFD subband configuration indicating the SBFD UL and DL subbands or alternatively, indicating the SBFD UL subband and guard bands using signaling messages such as RRC_SETUP or RRC_RECONFIGURATION. Frequency-domain or time-domain allocations of the second SBFD UL subband configuration may be indicated by means such as described in the case of the first SBFD subband configuration.

The indicated SBFD subband types of the first and second SBFD subband configurations may be same or different. For example, the first SBFD subbands configuration associated with SBFD operation in RRC_IDLE/INACTIVE mode may only indicate an SBFD UL SB. The second SBFD subbands configuration associated with SBFD operation in RRC_CONNECTED mode may indicate SBFD UL and DL subbands.

The time-domain SBFD symbol/slot or the frequency-domain allocation granularity may be same or different for the first and second SBFD subband configurations. For example, the first SBFD subbands configuration associated with SBFD operation in RRC_IDLE/INACTIVE mode may indicate possible SBFD UL subband sizes as integer multiple of N RBs where N=4 or 8 for illustration purposes. The second SBFD subbands configuration associated with SBFD operation in RRC_CONNECTED mode may indicate possible SBFD UL subband sizes with M RB resolution where M=1 for illustration purposes. For example, the first SBFD subbands configuration associated with SBFD operation in RRC_IDLE/INACTIVE mode may indicate possible SBFD time-domain allocations as integer multiple of N symbols where N=7 or 14 for illustration purposes. The second SBFD subbands configuration associated with SBFD operation in RRC_CONNECTED mode may indicate possible SBFD time-domain allocations with M symbol resolution where M=1 for illustration purposes.

The first and the second SBFD subband configurations may indicate SBFD operation on disjoint sets of SBFD symbols/slots or RBs, may share some SBFD symbols/slots or RBs, or the time-domain and frequency-domain resources indicated for SBFD operation in one SBFD subbands configuration may be included as a subset in the other SBFD subbands configurations.

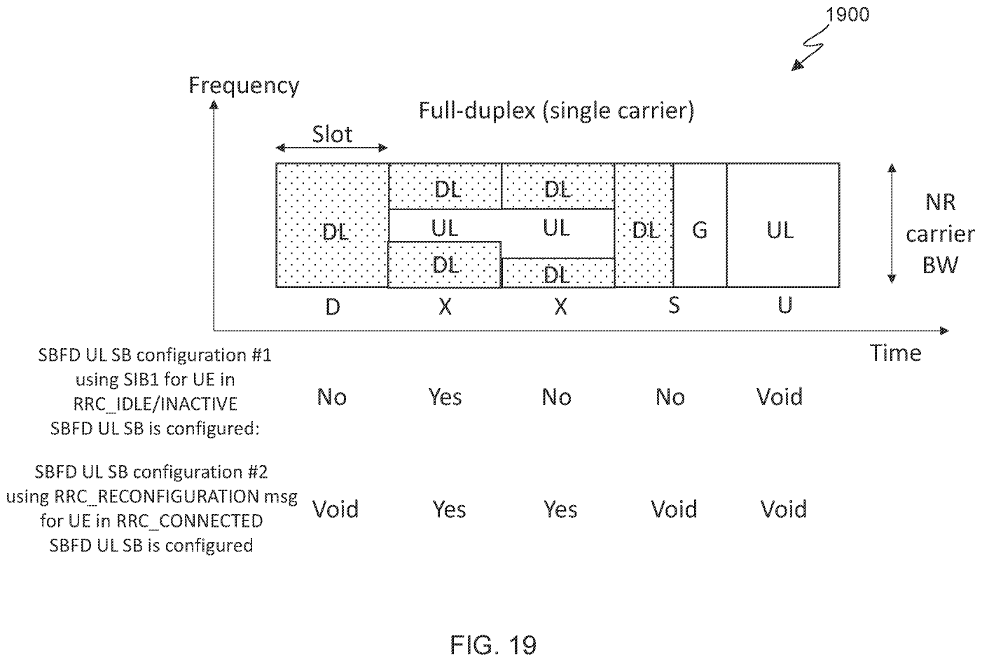

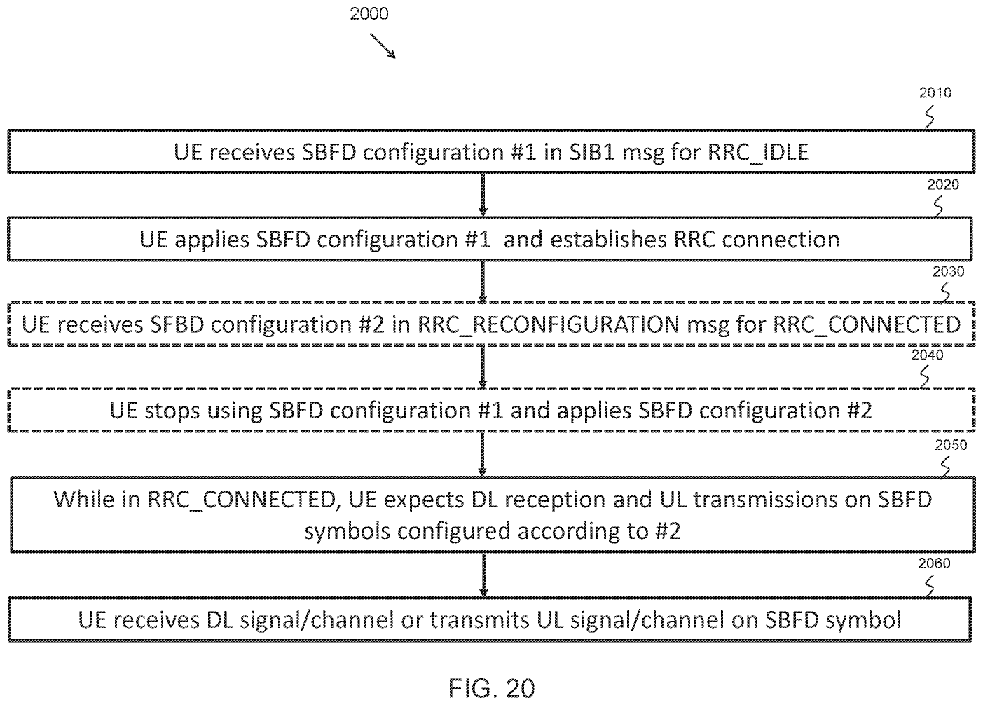

With reference to FIGS. 19 and 20, for example, the frequency locations of the first and second SBFD subband configurations on an SBFD symbol or in an SBFD slot may be the same or different. For example, as illustrated in FIG. 19, indicated time-domain locations of the first SBFD subband configuration may be the same as, or may include only a subset of entries provided by, the second SBFD subband configuration. FIG. 20 illustrates a UE processing flowchart for a method 2000 for determining applicable SBFD subband configurations associated with RRC states, such as, but not limited to, RRC_IDLE/INACTIVE or RRC_CONNECTED.

The method 200 begins with the UE receiving a SBFD configuration #1 in a SIB1 msg for RRC_IDLE, 2010. The UE then applies SBFD configuration #1 and establishes RRC connection, 2020. The UE then receives SFBD configuration #2 in RRC_RECONFIGURATION msg for RRC_CONNECTED, 2030. The UE then stops using SBFD configuration #1 and applies SBFD configuration #2, 2040. While in RRC_CONNECTED, the UE expects a DL reception and UL transmissions on SBFD symbols configured according to #2, 2050. The UE then receives a DL signal or channel or transmits an UL signal or channel on SBFD symbol, 2060.

In one example, using band n78 and SCS=30 kHz for illustration purposes, the NR carrier BW for UL transmissions and DL receptions is 273 RBs numbered from 0 to 272. CORESET #0, determining an initial DL BWP when a UE is in RRC_IDLE/INACTIVE, is configured with 48 RBs on RBs #120-167. The DL BWP and the UL BWP for the UE when in RRC_CONNECTED is 200 RBs, are provided to the UE using an RRC_RECONFIGURATION message, and correspond to RBs 0-199 of the NR carrier BW. The UE is provided a first SBFD subband configuration in SIB1 indicating an SBFD UL subband allocation on RBs 120-167 for all symbols in slot #3. The second SBFD UL subband allocation when in RRC_CONNECTED indicates to the UE all symbols in SBFD slots #2 and 3 and RBs 100-150 for SBFD operation. During initial access, the UE determines that UL transmissions may be scheduled or configured by the gNB in SBFD slot #3 on the indicated RBs 120-167 of the SIB1-indicated UL subband. After successful RRC connection establishment by the UE, such as after transitioning to RRC_CONNECTED mode, the UE determines that UL transmissions using the SBFD UL subband may be scheduled or configured by the gNB in SBFD slots #2 and #3 on the indicated RBs 100-150 of the UL subband valid for RRC_CONNECTED mode.

In various embodiments of this disclosure, an advantage when providing separate SBFD subband configurations for UEs in RRC_IDLE/INACTIVE and RRC_CONNECTED modes, respectively, is that SBFD operation can be controlled independently. A limited number of SBFD symbols/slots or a limited set of controlled SBFD UL RBs can be made available for SBFD UL transmissions to UEs in RRC_IDLE/INACTIVE mode, while the full set of SBFD symbols/slots and SBFD UL bandwidth in SBFD symbols is available for the UE in RRC_CONNECTED mode. When only indicating a subset of SBFD subband configuration to UEs in RRC_IDLE/INACTIVE mode, such as UL subband only, or using less allocation granularity in time or frequency-domains, SIB1 payload can be reduced. That is beneficial to preserve DL cell coverage with SBFD operation as SIB1 can be a coverage limiting channel, for example for UEs with reduced capabilities such as with a reduced number of receiver antennas. Full flexibility, such as symbol level and per-RB granularity SBFD configuration is possible for UEs in RRC_CONNECTED mode.

Any of the above variation embodiments can be utilized independently or in combination with at least one other variation embodiment.

The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method of operating a user equipment (UE), the method comprising:
receiving first information for a first set of parameters for a first frequency-domain subband associated with an uplink (UL) bandwidth for transmissions on a cell;
receiving second information for a second set of parameters for a second frequency-domain subband associated with a downlink (DL) bandwidth for receptions on the cell;
determining a third frequency-domain subband on a symbol based on the first frequency-domain subband, the second frequency-domain subband, and a reference bandwidth, wherein:
at least one of the first frequency-domain subband and the second frequency-domain subband is one of a subband full-duplex (SBFD) DL subband, an SBFD flexible subband, or an SBFD UL subband, and
the reference bandwidth is one of a carrier bandwidth, a bandwidth part (BWP), or a frequency-domain allocation with upper and lower limits; and
receiving or transmitting on the symbol, wherein a frequency-domain resource of the third frequency-domain subband is not available for receptions or transmissions on the symbol on the cell.

2. The method of claim 1, wherein determining the third frequency-domain subband on the symbol further comprises determining the third frequency-domain subband based on the first or the second frequency-domain subband of another symbol.

3. The method of claim 1, wherein:
determining the third frequency-domain subband on the symbol further comprises determining the third frequency-domain subband based on a frequency-domain limit (FDL) value,
the FDL value is associated with a minimum or maximum frequency-domain allocation value for the reference bandwidth, and
receiving or transmitting on the symbol further comprises receiving or transmitting on the symbol based on the minimum or maximum frequency-domain allocation value.

4. The method of claim 1, wherein:
determining the third frequency-domain subband on the symbol further comprises determining the third frequency-domain subband based on a frequency-domain allocation size (FDAS) value,
the FDAS value is associated with a minimum or maximum FDAS value for a frequency-domain subband,
the method further comprises determining a size of the third frequency-domain subband based on the minimum or maximum FDAS value.

5. The method of claim 1, wherein determining the third frequency-domain subband on the symbol further comprises determining the third frequency-domain subband based on a reference bandwidth of another symbol.

6. The method of claim 1, wherein:
determining the third frequency-domain subband on the symbol further comprises determining the third frequency-domain subband based on the reference bandwidth, and
the reference bandwidth corresponds to one of multiple configured DL or UL BWPs.

7. The method of claim 1, wherein:
determining the third frequency-domain subband on the symbol further comprises determining the third frequency-domain subband based on the reference bandwidth, and
the reference bandwidth is provided as a virtual BWP.

8. A user equipment (UE) comprising:
a transceiver configured to:
receive first information for a first set of parameters for a first frequency-domain subband associated with an uplink (UL) bandwidth for transmissions on a cell; and
receive second information for a second set of parameters for a second frequency-domain subband associated with a downlink (DL) bandwidth for receptions on the cell; and
a processor configured to determine a third frequency-domain subband on a symbol based on the first frequency-domain subband, the second frequency-domain subband, and a reference bandwidth,
wherein at least one of the first frequency-domain subband and the second frequency-domain subband is one of a subband full-duplex (SBFD) DL subband, an SBFD flexible subband, or an SBFD UL subband,
wherein the reference bandwidth is one of a carrier bandwidth, a bandwidth part (BWP), or a frequency-domain allocation with upper and lower limits,
wherein the transceiver is further configured to receive or transmit on the symbol, and
wherein a frequency-domain resource of the third frequency-domain subband is not available for receptions or transmissions on the symbol on the cell.

9. The UE of claim 8, wherein the processor is further configured to determine the third frequency-domain subband based on the first or the second frequency-domain subband of another symbol.

10. The UE of claim 8, wherein:
the processor is further configured to determine the third frequency-domain subband based on a frequency-domain limit (FDL) value,
the FDL value is associated with a minimum or maximum frequency-domain allocation value for the reference bandwidth, and
wherein the transceiver is further configured to receive or transmit on the symbol based on the minimum or maximum frequency-domain allocation value.

11. The UE of claim 8, wherein:
the processor is further configured to determine the third frequency-domain subband based on a frequency-domain allocation size (FDAS) value,
the FDAS value is associated with a minimum or maximum FDAS value for a frequency-domain subband,
the processor is further configured to determine a size of the third frequency-domain subband based on the minimum or maximum FDAS value.

12. The UE of claim 8, wherein the processor is further configured to determine the third frequency-domain subband based on a reference bandwidth of another symbol.

13. The UE of claim 8, wherein:
the processor is further configured to determine the third frequency-domain subband based on the reference bandwidth, and
the reference bandwidth corresponds to one of multiple configured DL or UL BWPs.

14. The UE of claim 8, wherein:
the processor is further configured to determine the third frequency-domain subband based on the reference bandwidth, and
the reference bandwidth is provided as a virtual BWP.

15. A base station (BS) comprising:
a transceiver configured to:
transmit first information for a first set of parameters for a first frequency-domain subband associated with an uplink (UL) bandwidth for receptions on a cell; and
transmit second information for a second set of parameters for a second frequency-domain subband associated with a downlink (DL) bandwidth for transmissions on the cell; and
a processor configured to determine a third frequency-domain subband on a symbol based on the first frequency-domain subband, the second frequency-domain subband, and a reference bandwidth,
wherein at least one of the first frequency-domain subband and the second frequency-domain subband is one of a subband full-duplex (SBFD) DL subband, an SBFD flexible subband, or an SBFD UL subband,
wherein the reference bandwidth is one of a carrier bandwidth, a bandwidth part (BWP), or a frequency-domain allocation with upper and lower limits,
wherein the transceiver is further configured to receive or transmit on the symbol, and
wherein a frequency-domain resource of the third frequency-domain subband is not available for receptions or transmissions on the symbol on the cell.

16. The BS of claim 15, wherein the processor is further configured to determine the third frequency-domain subband based on the first or the second frequency-domain subband of another symbol.

17. The BS of claim 15, wherein:
the processor is further configured to determine the third frequency-domain subband based on a frequency-domain limit (FDL) value,
the FDL value is associated with a minimum or maximum frequency-domain allocation value for the reference bandwidth, and
wherein the transceiver is further configured to receive or transmit on the symbol based on the minimum or maximum frequency-domain allocation value.

18. The BS of claim 15, wherein:
the processor is further configured to determine the third frequency-domain subband based on a frequency-domain allocation size (FDAS) value,
the FDAS value is associated with a minimum or maximum FDAS value for a frequency-domain subband,
the processor is further configured to determine a size of the third frequency-domain subband based on the minimum or maximum FDAS value.

19. The BS of claim 15, wherein the processor is further configured to determine the third frequency-domain subband based on a reference bandwidth of another symbol.

20. The BS of claim 15, wherein:
the processor is further configured to determine the third frequency-domain subband based on the reference bandwidth, and
the reference bandwidth corresponds to one of multiple configured DL or UL BWPs.
